(19) United States
(12) Patent Application Publication
(10) Pub. No.: US 2019/0270043 A1
(43) Pub. Date: Sep. 5, 2019

(54) TRAP, TRAP DEVICE, AND TRAP SYSTEM

(71) Applicant: ALPHATECH LTD., Kanagawa (JP)

(72) Inventor: Kazutoshi NAGASAWA, Kanagawa (JP)

(21) Appl. No.: 16/289,953

(22) Filed: Mar. 1, 2019

(30) Foreign Application Priority Data
Mar. 2, 2018 (JP) 2018-037700
Feb. 21, 2019 (JP) 2019-029120

(51) Int. Cl. B01D 45/04

(52) U.S. Cl. CPC B01D 45/04; B01D 53/38

(57) ABSTRACT

A trap device includes a first gas inlet introducing a waste gas after use, a heater-installed duct provided with a heater in a first gas flow path through which the introduced waste gas flows, a trap capturing by-products by cooling the waste gas after flowing through the heater-installed duct, and a communication member connecting the heater-installed duct to the trap.

### CROSS-REFERENCE TO RELATED APPLICATION

Priority is claimed on Japanese applications No. 2018-037700 filed on Mar. 2, 2018 and 2019-029120 filed on Feb. 21, 2019, the contents of which are incorporated herein by reference.

### FIELD

The disclosure relates to a trap, a trap device, and a trap system, and more specifically relates to a trap device, and a trap system which capture by-products generated in a used reaction gas after use in manufacturing and processing for semiconductor or the like (hereinafter such a gas is simply referred to as a waste gas).

### BACKGROUND

Heretofore, the waste gas having been used for etching, film formation, ion implantation, or the like in the manufacturing and processing for semiconductor and containing hazardous substances is under a regulation that the waste gas must be treated with a detoxifying apparatus for rendering the waste gas harmless and be discarded in the harmless state. In this case, the waste gas is transported through a duct from a processing apparatus such as an etching apparatus to the detoxifying apparatus.

During this transportation, by-products remaining in the waste gas or generated while the waste gas is passing the duct adhere to the inner surface of the duct wall, and block the waste gas flow. To prevent this, it is common practice to heat the inside of the duct to a predetermined temperature or higher, thereby preventing by-products of the reaction gas from adhering to the inner surface of the duct wall.

In methods of raising the temperature in the duct to the predetermined temperature or higher, the inside of the duct is heated from the outside or inside the duct as described in Japanese Patent No. 5244974. Thus, the temperature in the duct is raised to prevent the by-products from being generated from the waste gas and adhering to the inner surface of the duct wall.

In the background technique, however, after the waste gas flows in the detoxifying apparatus, the waste gas is cooled and generates by-products and the by-products occlude clearances between particles of a detoxifying agent.

To address this, a trap for removing the by-products from the waste gas is connected to a gas flow path upstream of the detoxifying apparatus in some cases.

In this regard, there are a trap which removes by-products generated during the processing in the processing apparatus and transported together with the waste gas, and a trap which cools the waste gas to generate by-products and removes the by-products.

As for the latter trap, the waste gas is transported to the trap while the inside of the duct is heated to the predetermined temperature or higher to prevent by-products from being generated from the waste gas and adhering to the inner surface of the duct wall. However, the trap includes a gas introduction path provided from the inlet of the trap to the inside of the trap, and the by-products adhere to the gas introduction path and block a gas flow in the gas introduction path. This is because the latter trap generates and captures by-products by cooling the waste gas, which means that the latter trap is configured to cool the gas in principle.

One possible approach to this is to set a temperature margin large enough to prevent generation of by-products even when the temperature of the waste gas drops to some extent. In this case, however, the heater consumes the electric power wastefully. Moreover, this approach requires the trap to achieve high cooling performance because the temperature of the waste gas is high.

Embodiments have been devised with consideration given to the above problems, and are intended to provide a trap, a trap device, and a trap system, which are capable of capturing by-products while retarding clogging of a waste gas flow path with by-products by efficiently heating a waste gas.

### SUMMARY

According to an embodiment to solve the above-described problems, provided is a trap including: a housing including a gas inlet and a gas outlet; a gas introduction chamber provided in the housing and including the gas inlet; a gas flow path provided in the housing and communicating with the gas outlet; a partition separating the gas introduction chamber and the gas flow path; and a vent hole provided in the partition.

According to another aspect of an embodiment, provided is a trap system including: a heater-installed duct including a heater in a first gas flow path conducting a waste gas after use; a duct through which the waste gas discharged from the heater-installed duct flows; and a trap including a housing including a gas outlet and a gas inlet introducing the waste gas discharged from the duct, a gas introduction chamber provided in the housing and including the gas inlet, a second gas flow path provided in the housing and including the gas outlet, a partition separating the gas introduction chamber and the second gas flow path, and a vent hole provided in the partition.

According to another aspect of an embodiment, provided is a trap device including a first gas inlet introducing a waste gas after use, a heater-installed duct connected to the first gas inlet and provided with a heater installed in a first gas flow path through which the waste gas introduced flows, a trap capturing by-products by cooling the waste gas after flowing through the heater-installed duct, and a communication member connecting the heater-installed duct to the trap.

According to another aspect of an embodiment, provided is a detoxifying system including: a trap device including a first gas inlet connected to a processing apparatus using a gas, and introducing a waste gas after using the gas, a heater-installed duct connected to the first gas inlet and provided with a heater installed in a first gas flow path through which the waste gas introduced flows, a trap capturing by-products by cooling the waste gas after flowing through the heater-installed duct, and a communication member connecting the heater-installed duct to the trap; and a detoxifying apparatus connected to a gas outlet of the trap device through a duct conducting the waste gas.

According to the trap device of the embodiment, the waste gas is directly heated by the heater inside the heater-installed duct, and thereby is efficiently heated to a predetermined temperature.

In addition, since the waste gas heated by the heater transfers to the trap through the communication member, the temperature of the waste gas does not drop very much until the waste gas reaches the inside of the trap through the gas flow path inside the communication member. Thus, by using a smaller amount of electric power, the waste gas can be kept at a temperature higher than the upper limit of a temperature range in which by-products will be generated.

Moreover, since the waste gas is directly heated by the heater provided in the duct at a preceding location close to the trap, the waste gas undergoes only a small change in temperature while passing the inlet of the trap.

Thus, the waste gas can be heated with the minimum electric power margin.

Accordingly, before the waste gas enters the inside of the trap, generation of by-products can be prevented more reliably by using a smaller amount of electric power.

Such efficient heating enables retardation of clogging of the waste gas flow path with by-products.

Meanwhile, the detoxifying system of the embodiment includes the trap device connected to the processing apparatus using the gas, and the detoxifying apparatus connected to the gas outlet of the trap device through the duct conducting the waste gas.

Hence, the structure of the gas discharge line can be simplified because the processing apparatus and the trap device can be directly connected through a dry pump or the like without any heater-installed duct externally provided in between, and there is no need to provide any means for heating the waste gas in any location downstream of the trap device.

### BRIEF DESCRIPTION OF DRAWINGS

FIG. 1A is a perspective view illustrating a trap device according to an embodiment, and FIG. 1B is a side view of the trap device in FIG. 1A;

FIG. 2A is a cross sectional view illustrating a heater-installed duct used in the trap device in FIG. 1, and FIG. 2B is an enlarged perspective view illustrating a portion encompassed by a dash-dotted line in Fig. FIG. 2A;

FIG. 3 is a schematic diagram illustrating a detoxifying system using the trap device in FIG. 1;

FIG. 4 is a side view illustrating a first modified embodiment in which a communication member in the trap device in FIG. 1 includes only flanges;

FIG. 5 is a side view illustrating a second modified embodiment in which a flow path selector switch is used as a communication member in the trap device in FIG. 1;

FIG. 6 is an enlarged perspective view illustrating the flow path selector switch in FIG. 5;

FIG. 7A is a cross sectional view illustrating an I-cross section of FIG. 6, and FIG. 7B is a cross sectional view illustrating a J-cross section of FIG. 6;

FIG. 8 is an enlarged perspective view illustrating a state where the flow path is switched by operating a rotary shaft of the flow path selector switch in FIG. 6;

FIG. 9A is a cross sectional view illustrating an I-cross section of FIG. 8, and FIG. 9B is a cross sectional view illustrating a J-cross section of FIG. 8;

FIG. 10A is an enlarged upper side view illustrating a modified embodiment of the flow path selector switch in FIGS. 6 and 8, and FIG. 10B is an enlarged upper side view illustrating a state where the flow path is switched by operating a rotary shaft of the flow path selector switch in FIG. 10A;

FIG. 11A is a cross sectional view that illustrates a third modified embodiment in which the structure including a first gas flow path and its surroundings of the trap device in FIG. 5 is modified, and that corresponds to the FIG. 7A, and FIG. 11B is a cross sectional view taken along a k-k line in FIG. 11A;

FIG. 12 is a perspective view illustrating a structure of a trap in a trap device according to an embodiment;

FIGS. 13A and 13B are perspective views illustrating two types of structures of a capture member installed in the trap in FIG. 12;

FIG. 14 is a perspective view illustrating a specific structure of a capture body illustrated in FIG. 13A;

FIG. 15 is a cross sectional view taken along a I-I line in FIG. 12;

FIG. 16 is a side view illustrating a fourth modified embodiment of the trap device according to the embodiment;

FIG. 17 is a perspective view illustrating a structure of the trap in FIG. 16;

FIGS. 18A and 18B are perspective views illustrating two types of structures of a capture member installed in the trap in FIG. 16;

FIG. 19 is a perspective view illustrating a specific structure of a capture body in FIG. 18A;

FIG. 20 is a cross sectional view taken along a II-II line in FIG. 17;

FIG. 21 is a perspective view illustrating a fifth modified embodiment of the trap device according to the embodiment;

FIG. 22 is a cross sectional view taken along a III-III line in FIG. 21;

FIG. 23 is a perspective view illustrating a sixth modified embodiment of the trap device according to the embodiment;

FIG. 24 is a cross sectional view illustrating a seventh modified embodiment of the trap device according to the embodiment;

FIG. 25 is a cross sectional view illustrating an eighth modified embodiment of the trap device according to the embodiment;

FIG. 26A is a cross sectional view illustrating a ninth modified embodiment of the trap device according to the embodiment;

FIG. 26B is a cross sectional view illustrating a tenth modified embodiment of the trap device according to the embodiment; and

FIG. 27 is a schematic diagram illustrating a trap system according to an embodiment.

### DESCRIPTION OF EMBODIMENTS

Hereinafter, embodiments are described with reference to the drawings.

### (1) Structure of Trap Device of Embodiment

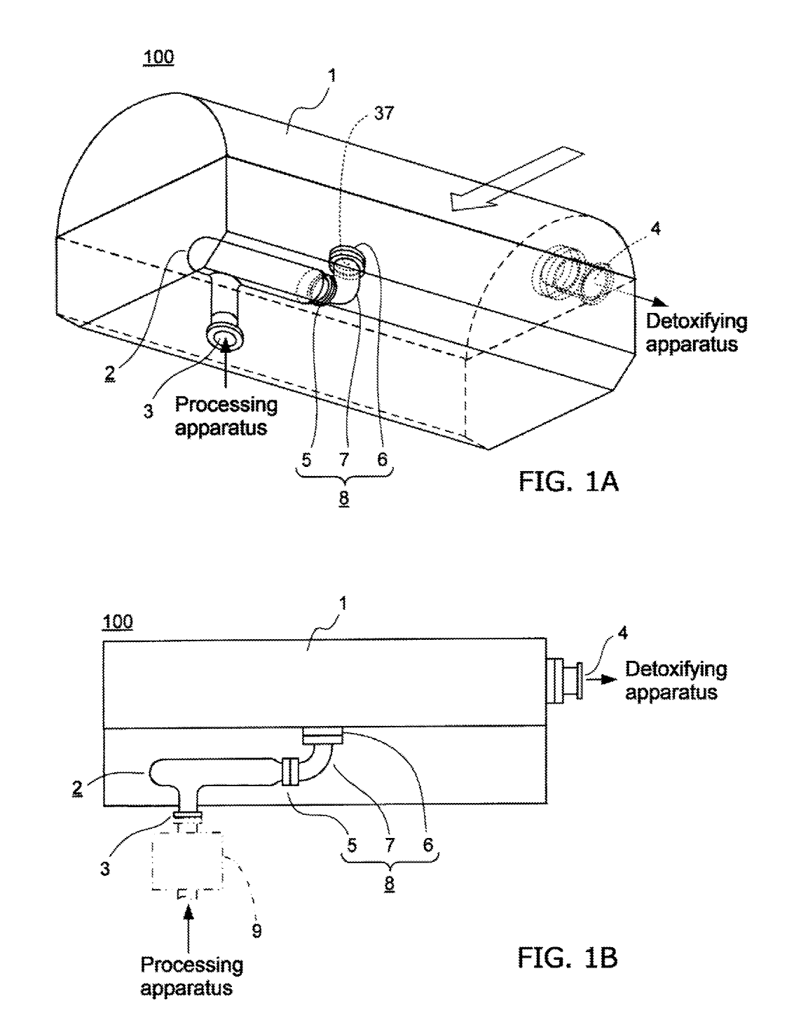

FIG. 1A is a perspective view illustrating a trap device 100 according to an embodiment viewed obliquely from a front upper side, and FIG. 1B is a side view of the trap device 100 in FIG. 1A viewed in a direction indicated by an outlined white arrow.

The trap device 100 according to the embodiment includes: a gas inlet 3 which introduces a used reaction gas (hereinafter referred to as a waste gas) discharged from a processing apparatus such as an etching apparatus, a film forming apparatus, or an ion implantation apparatus; a heater-installed duct 2 connected to the gas inlet 3 and provided with a heater in a gas flow path through which the waste gas flows; a semi-cylindrical trap 1 which captures by-products by cooling the waste gas; and a gas outlet 4 through which the waste gas from which the by-products are removed in the trap 1 is discharged from the trap device 100.

The waste gas discharged from the gas outlet 4 is conducted through a duct to a detoxifying apparatus for rendering the waste gas harmless as described later.

In addition, the trap device 100 includes a communication member 8. The communication member 8 connects the heater-installed duct 2 and the trap 1 to allow the heater-installed duct 2 to communicate with the trap 1. The waste gas discharged from the heater-installed duct 2 after flowing through the heater-installed duct 2 is conducted to the trap 1 by the communication member 8.

The communication member 8 includes a gas-conducting pipe 7 through which the waste gas discharged from the heater-installed duct 2 flows and is conducted to the trap 1, a flange 5 provided to the duct 2 in order to be connected to one end of the gas-conducting pipe 7, and a flange 6 provided in the trap 1 in order to be connected to the other end of the gas-conducting pipe 7.

Here, both ends of the gas-conducting pipe 7 are also provided with flanges. As illustrated in the drawings, the flanges of the gas-conducting pipe 7 are joined and fixed to the flange 5 of the duct 2 and the flange 6 of the trap 1 by bringing the flanges of the gas-conducting pipe 7 into contact with the flanges 5 and 6, respectively, and fastening them by screws or the like. In this way, a gas flow path leading to the trap 1 from the duct 2 is hermetically sealed from the outside. The communication member 8 includes the flanges provided at both ends of the gas-conducting pipe 7. The flanges 5 and 6 and the gas-conducting pipe 7 including the flanges are made of, for example, stainless steel.

As illustrated in FIG. 1B, a pump 9 is connected to the gas inlet 3, and a processing apparatus is connected to the pump 9. This pump 9 forms a flow of the waste gas discharged from the processing apparatus toward the trap device 100.

The trap 1 is a particle trap having a device structure in which the waste gas is cooled while flowing inside a housing of the trap 1 to generate by-products, and the by-products are captured by, for example, adhesion to adsorbent sheets. A commercially available well-known trap device or the like may be also used as the trap 1.

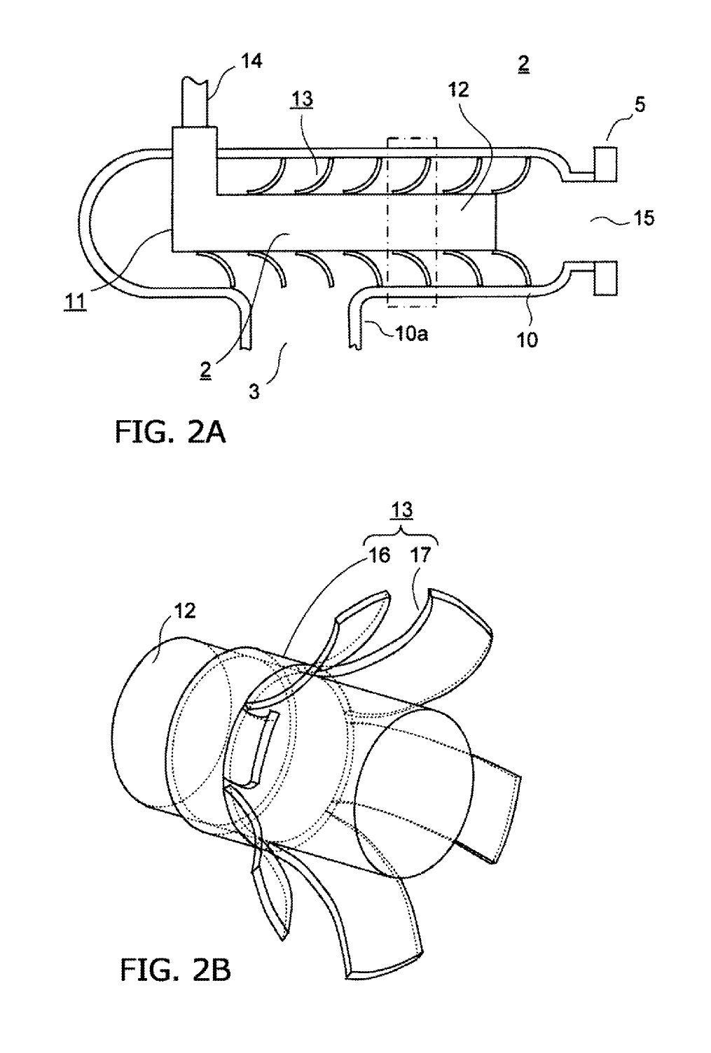

Next, a structure of the heater-installed duct 2 is described with reference to FIGS. 2A and 2B.

FIG. 2A is a cross sectional view illustrating the heater-installed duct used in the trap device according to the embodiment, and FIG. 2B is an enlarged perspective view illustrating a portion encompassed by a dash-dotted line in FIG. 2A.

The heater-installed duct 2 is, for example, made of stainless steel and has a cylindrical shape as illustrated in FIG. 2A. More specifically, the heater-installed duct 2 has a structure in which a heater unit 11 is installed inside a cylindrical outer wall 10 having one end closed and the other end (open end) 15 opened.

Moreover, a through hole is formed in a side surface of the cylindrical outer wall 10, and one end of another cylindrical outer wall 10a is connected to the through hole. The other end of the cylindrical outer wall 10a serves as the gas inlet 3 of the trap device 100.

The waste gas introduced through the gas inlet 3 flows through the cylindrical outer wall 10a, and is introduced into the cylindrical outer wall 10. Then, the waste gas flows inside the cylindrical outer wall 10, and is discharged from the open end 15 of the cylindrical outer wall 10 after the waste gas is heated by the heater unit 11. The open end 15 is provided with the flange 5 with which the cylindrical outer wall 10 can be connected to the gas-conducting pipe 7 connected to the trap 1.

The heater unit 11 includes a cylindrical sheathed heater 12 and multiple fin units 13 attached to the sheathed heater 12 at preferably equal intervals as illustrated in FIG. 2B. A lead wire 14 for supplying electric power is connected to the sheathed heater 12.

Each fin unit 13 includes a cylindrical base 16 where to insert the sheathed heater 12, and multiple fins 17 arranged along the circumference of one end of the base 16. The fin unit 13 is made of, for example, stainless steel.

Each fin 17 is arranged with its wide surface opposed to a waste gas flow. Thus, the heat from the sheathed heater 12 is transmitted by heat conduction to the outer circumference of the gas flow path in the duct 2 through the fins 17, and the fins 17 disturb the passing waste gas flow to disperse the thermal energy, thereby making the thermal distribution uniform in the duct 2.

Here, an outer jacket of the sheathed heater 12 may be double pipes including an inner pipe and an outer pipe. In this case, the air is sealed between the inner and outer pipes, and the internal pressure is monitored so as to immediately detect that a hole is opened in the outer pipe due to corrosion.

As described above, the trap device 100 of the embodiment includes the heater-installed duct 2 provided with the heater in the gas flow path, the trap 1 which captures by-products in the waste gas after flowing through the duct 2, and the communication member 8 which connects the heater-installed duct 2 to the trap 1 and allows the heater-installed duct 2 to communicate with the trap 1.

The waste gas can be efficiently heated to a predetermined temperature by being directly heated by the heater unit 11 in the heater-installed duct 2.

In addition, since the waste gas heated by the heater unit 11 transfers to the trap 1 through the communication member 8, the temperature of the waste gas does not drop very much until the waste gas reaches the inside of the trap 1 through the gas flow path inside the communication member 8.

Moreover, since the fins 17 are provided in the gas flow path around the outer circumference of the heater in the duct, the flowing waste gas is disturbed to have good temperature uniformity. Thus, the waste gas undergoes only a small change in temperature while passing the inlet of the trap 1.

Thus, the waste gas can be heated with a minimum electric power margin. Accordingly, before the waste gas enters the inside of the trap 1, generation of by-products can be prevented more reliably by using a smaller amount of electric power than in the conventional one.

The efficient heating as described above enables retardation of clogging of the waste gas flow path with by-products.

Meanwhile, there is a method of heating the waste gas flowing in the flow path through the outer wall surrounding the flow path, more specifically, a method of heating the waste gas by a heater attached to the outer circumferential surface of the outer wall, for example, a method of heating the waste gas by a ribbon heater. Nevertheless, this method requires the outer wall to be heated simultaneously, and accordingly needs a large amount of electric power supplied to the heater. The larger the thickness of the outer wall, the larger the necessary amount of electric power.

Moreover, in the case where the surface of the outer wall is stepped as in the joint portion provided with the flanges, it is difficult to bring the ribbon heater into close contact with the outer wall. Accordingly, efficient heat conduction is difficult.

In addition, since the waste gas is heated from the outside of the duct, the temperature uniformity of the gas flow may become worse in the duct because a temperature variation occurs from the duct inner wall side toward the duct center in the temperature distribution.

### (2) Detoxifying System of Embodiment

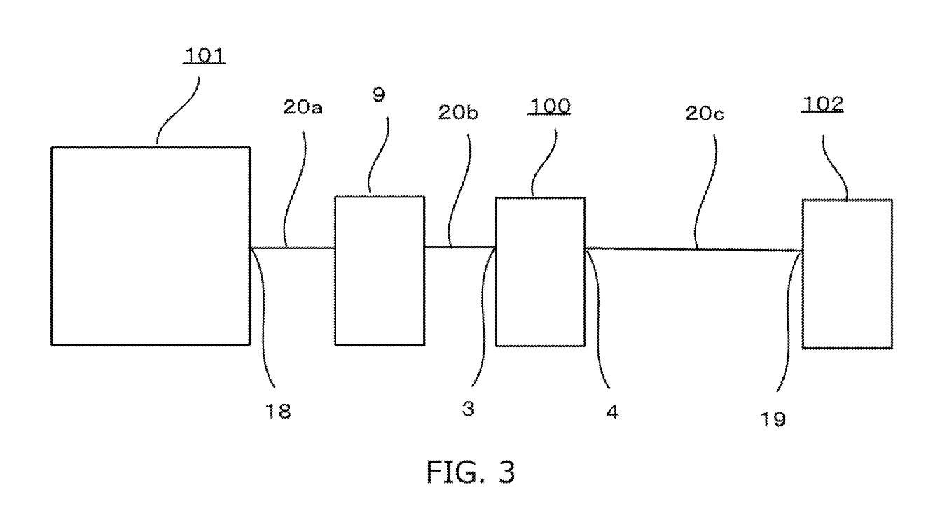

Next, a detoxifying system of the embodiment is described with reference to FIG. 3.

The detoxifying system of the embodiment includes a processing apparatus 101, the pump 9, and the trap device 100 in FIG. 1, and a detoxifying apparatus 102. The processing apparatus 101 is an etching apparatus, a film forming apparatus, an ion implantation apparatus, or the like.

To form a gas flow path 20a connecting the processing apparatus 101 and the pump 9, a gas outlet 18 of the processing apparatus 101 is connected to a gas inlet of the pump 9 directly or through a duct. The duct may be any one of the heater-installed duct 2 and a normal duct with no heater.

To form a gas flow path 20b connecting the pump 9 and the trap device 100, a gas outlet of the pump 9 is connected to the gas inlet 3 of the trap device 100 directly or through a duct. In the case where the duct is connected, the heater-installed duct 2 is connected to the gas outlet of the pump 9, and at least one normal duct with no heater is connected to the gas outlet of the duct 2. The number of ducts is adjusted such that the temperature of the waste gas in the gas introduction path leading from the gas inlet 3 to the inside of the trap device 100 may be kept higher than an upper limit of a temperature range in which by-products will be generated.

To form a gas flow path 20c connecting the gas outlet 4 of the trap device 100 and a gas inlet 19 of the detoxifying apparatus 102, only a normal duct with no heater may be connected, because the by-products are already removed from the waste gas by the trap device 100.

As described above, according to the detoxifying system of the embodiment, the processing apparatus 101, the pump 9, and the trap device 100 may be connected together directly. Even in this case, no matter how the temperature of the waste gas flowing out of the processing apparatus 101 or the pump 9 fluctuates, the temperature of the waste gas entering the trap 1 of the trap device 100 can be commonly adjusted to a temperature at which by-products will not be generated. This is because the waste gas just before entering the trap device 100 is heated by the heater of the heater-installed duct 2. It is unnecessary to externally provide a heater-installed duct to the flow path from the processing apparatus 101 to the trap device 100.

Moreover, since the by-products are removed by the trap device 100, a duct provided downstream of the trap device 100 can be simplified, that is, may use a normal duct with no heater.

Thus, the waste gas discharge line is significantly simplified.

### (3) First Modified Embodiment of Trap Device in FIG. 1

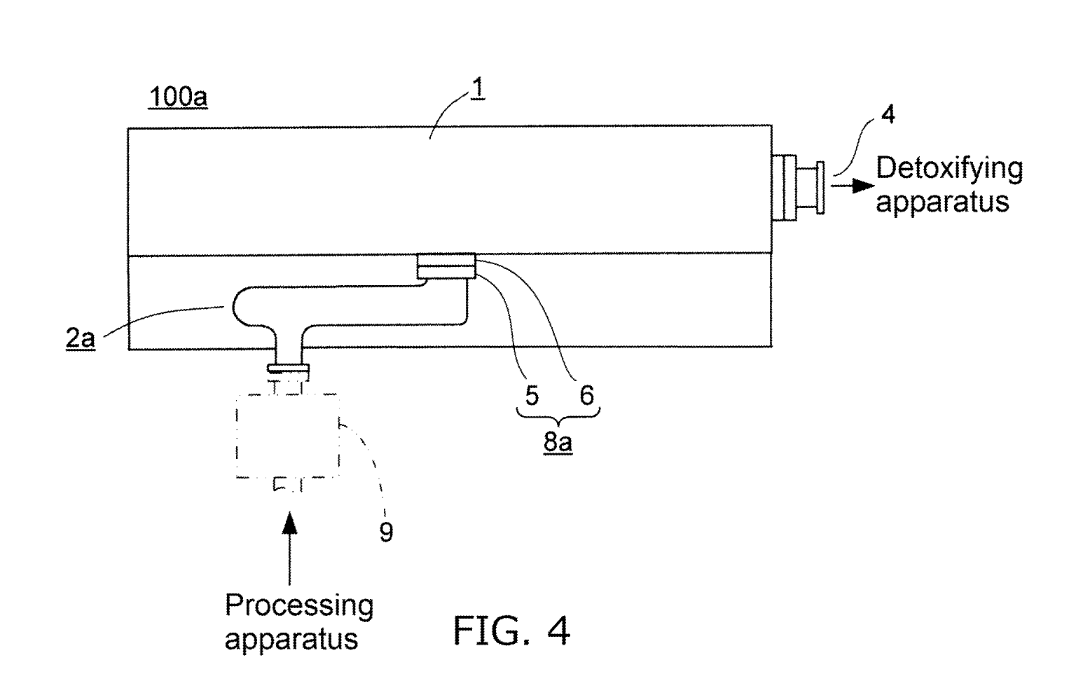

Next, a first modified embodiment of the trap device in FIG. 1 is described with reference to FIG. 4.

FIG. 4 is a side view illustrating of the first modified embodiment of the trap device in FIG. 1.

A trap device 100a of the first modified embodiment is different from the trap device in FIG. 1 in a structure of a communication member 8a in which flanges directly communicate with each other. As illustrated in FIG. 4, a heater-installed duct 2a and the trap 1 are directly connected to each other with their respective flanges 5 and 6 without the gas-conducting pipe 7 in FIG. 1.

The heater-installed duct 2a is bent upward around an open end 15, or a portion of the heater-installed duct 2a including the flange 5 around the open end 15 is bent toward the trap 1.

A communication member 8a includes the flange 5 of the heater-installed duct 2a and the flange 6 of the trap 1 as illustrated in FIG. 4.

The trap device 100a of the first modified embodiment also includes one set of the heater-installed duct 2a and the trap 1 as in the trap device 100 in FIG. 1. Therefore, the trap device 100a is capable of capturing and removing by-products from the waste gas while retarding clogging of the waste gas flow path with by-products by efficiently heating the waste gas.

Moreover, a detoxifying system using the trap device 100a of the first modified embodiment may also have a simple system structure.

### (4) Second Modified Embodiment of Trap Device in FIG. 1

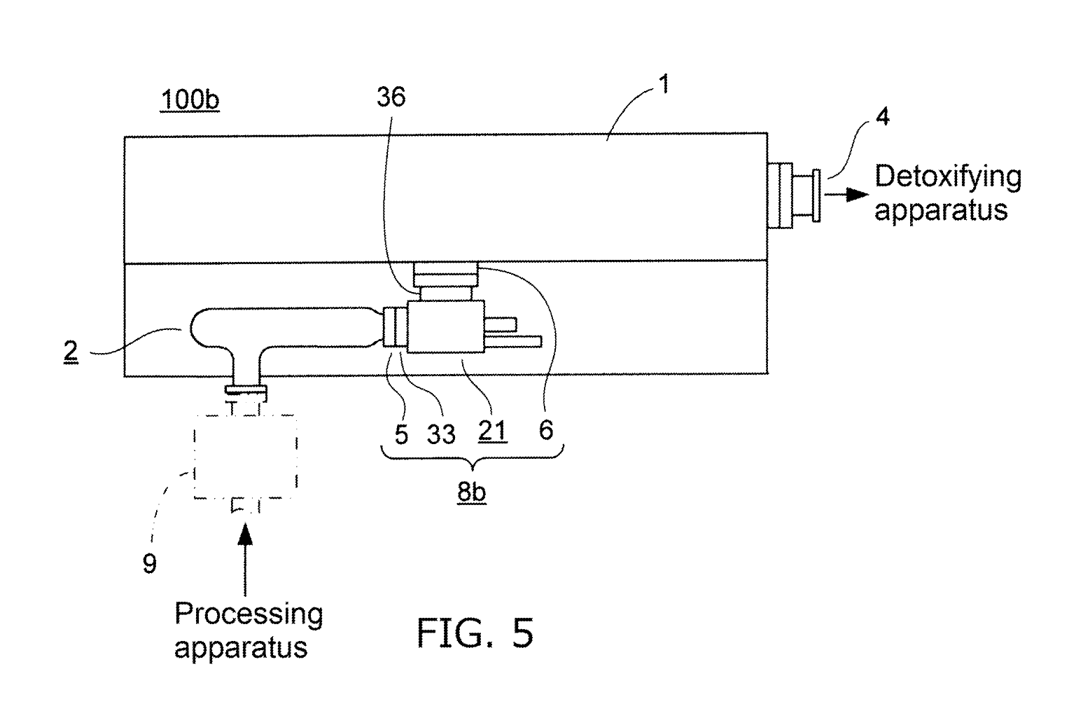

Next, a second modified embodiment of the trap device in FIG. 1 is described with reference to FIG. 5.

FIG. 5 is a side view illustrating of the second modified embodiment of the trap device in FIG. 1.

The trap device 100b of the second modified embodiment is different from the trap device in FIG. 1 in a structure of a communication member 8b which connects the heater-installed duct 2 to the trap 1 and allows the heater-installed duct 2 to communicate with the trap 1. Specifically, the communication member 8b uses a flow path selector switch 21 in place of the gas-conducting pipe 7 in FIG. 1 as illustrated in FIG. 5.

The communication member 8b includes the flange 5 of the heater-installed duct 2, the flange 6 of the trap 1, and the flow path selector switch 21 as illustrated in FIG. 5. The flow path selector switch 21 is made of, for example, stainless steel.

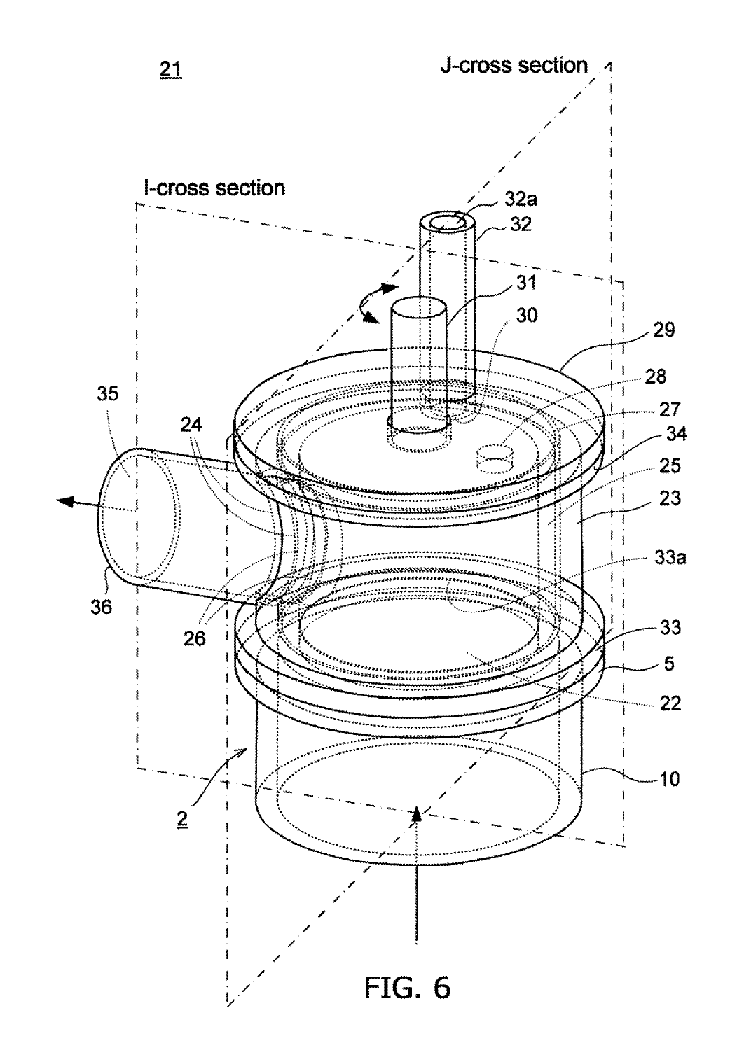

Next, the structure and the operation of the flow path selector switch 21 are described with reference to FIGS. 6 to 9.

FIG. 6 is an enlarged perspective view illustrating the flow path selector switch 21 in FIG. 5.

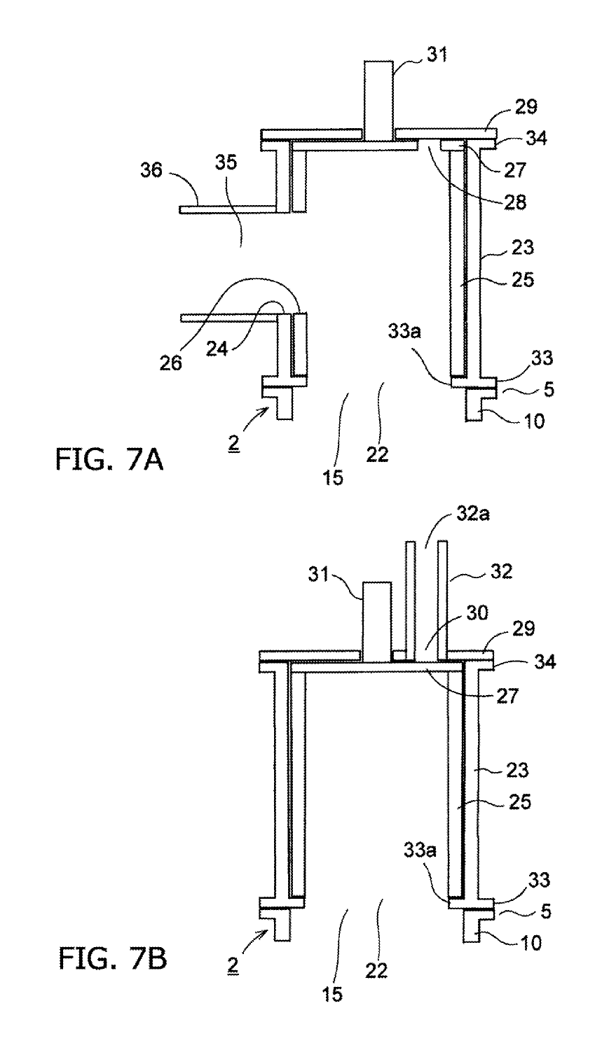

FIG. 7A is a cross sectional view illustrating an I-cross section of FIG. 6, and FIG. 7B is a cross sectional view illustrating a J-cross section of FIG. 6.

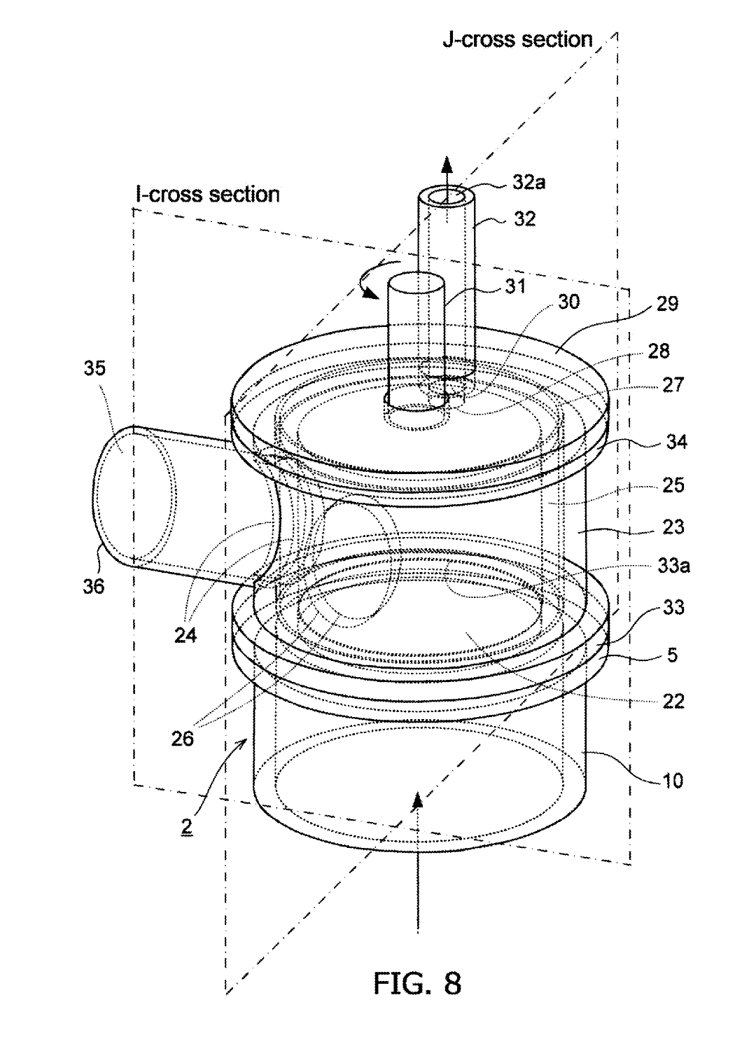

FIG. 8 is an enlarged perspective view illustrating a state where the flow path is switched by operating a rotary shaft 31 of the flow path selector switch 21 in FIG. 6.

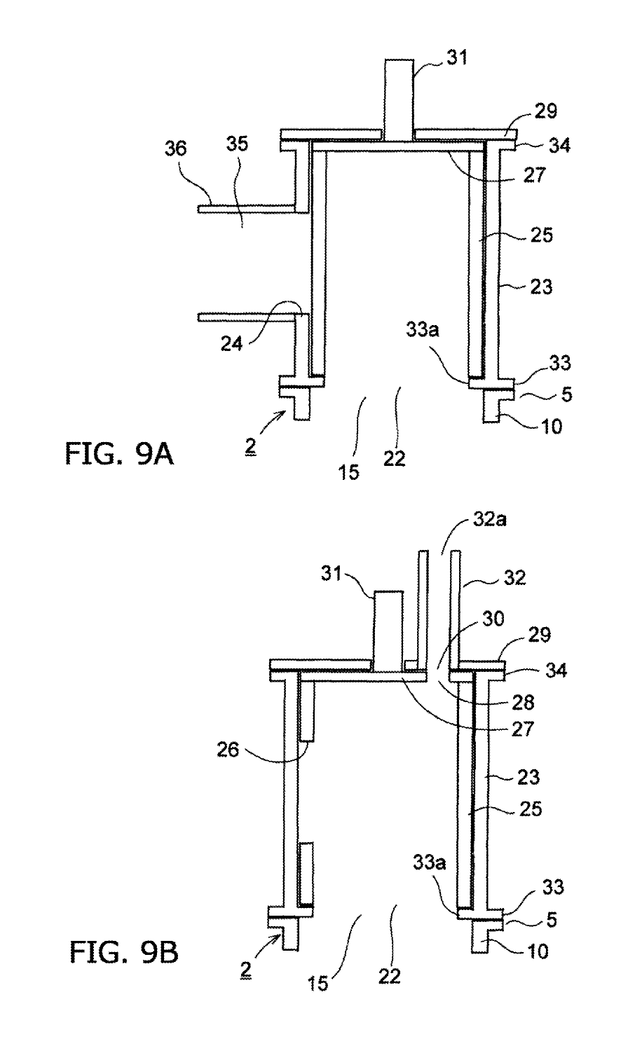

FIG. 9A is a cross sectional view illustrating an I-cross section of FIG. 8, and FIG. 9B is a cross sectional view illustrating a J-cross section of FIG. 8.

### (Structure of Flow Path Selector Switch 21)

First, the structure of the flow path selector switch 21 is described with reference to FIGS. 5, 6, 7, and 1.

The flow path selector switch 21 has a function to divert the gas discharged from the heater-installed duct 2 to any one of a first gas flow path 35 leading to the trap 1, and a second gas flow path 32a leading to a gas discharge side.

The flow path selector switch 21 includes a cylindrical outer wall 23, a gas inlet 22 which is provided at a lower end of the cylindrical outer wall 23 and which introduces the waste gas discharged from the heater-installed duct 2, and a first vent hole 24 provided at a side surface of the cylindrical outer wall 23. In FIG. 6, reference sign 33 indicates a flange which is provided at the lower end of the cylindrical outer wall 23, and is to be joined to the flange 5 at the open end 15 of the heater-installed duct 2.

The first gas flow path 35 is connected to the first vent hole 24. The first gas flow path 35 is formed inside a gas-conducting pipe 36. The first vent hole 24 is connected to the trap 1 through the first gas flow path 35.

In addition, a rotary tool 25 which is rotatable along the inner surface of the cylindrical outer wall 23 is provided inside the cylindrical outer wall 23. The rotary tool 25 has a cylindrical shape, and a lower end of the rotary tool 25 is supported by a support projection 33a of the cylindrical outer wall 23. Then, a side surface of the cylindrical rotary tool 25 is provided with a second vent hole 26 which is mated to the first vent hole 24 with rotation of the rotary tool 25.

Additionally, a disc-shaped first cover member 27 which covers an open end of the cylindrical rotary tool 25 and rotates together with the rotary tool 25 is provided at an upper end of the cylindrical rotary tool 25. A third vent hole 28 is provided at a predetermined location in the first cover member 27.

Moreover, a doughnut-shaped flange 34 is provided at an upper end of the cylindrical outer wall 23 around the first cover member 27. The flange 34 is extended outward from the cylindrical outer wall 23. The flange 34 is provided in such close proximity to the first cover member 27 as to cause no interference with the rotation of the first cover member 27 and to inhibit, as much as possible, the waste gas from flowing through a clearance between an inner rim of the flange 34 and an outer rim of the first cover member 27.

In addition, a second cover member 29 which covers the first cover member 27 and the flange 34 is provided. A fourth vent hole 30 is provided at a predetermined location in the second cover member 29. The fourth vent hole 30 is mated to the third vent hole 28 with rotation of the rotary tool 25. Then, a cylindrical gas-conducting pipe 32 connected to the fourth vent hole 30 and having the second gas flow path 32a is provided.

Moreover, a rotary shaft 31 is provided to stand on a center part of the first cover member 27, and protrudes upward from the second cover member 29 through a through hole provided in the second cover member 29. The first cover member 27 and the rotary tool 25 can be rotated together by rotating the rotary shaft 31.

Here, in order to prevent gas leakage, it is preferable to insert a ring-shaped elastic seal member between the first cover member 27 and the second cover member 29 or between the side surface of the through hole in the second cover member 29 and the rotary shaft 31.

### (Operation of Flow Path Selector Switch 21)

Next, the operation of the flow path selector switch 21 is described with reference to FIGS. 6 to 9 and FIGS. 1 to 3.

In FIGS. 6 and 7, the rotary shaft 31 of the flow path selector switch 21 is rotated to set the flow path selector switch 21 in a state of diverting the waste gas discharged from the heater-installed duct 2 to the first gas flow path 35 leading to the trap 1. In other words, the second vent hole 26 is mated to the first vent hole 24, while the third vent hole 28 is unmated from the fourth vent hole 30.

In this state, the waste gas flow to the trap device 100b is formed by the pump 9, and the waste gas after use discharged from the processing apparatus 101 is introduced into the trap device 100b from the gas inlet 3 through the pump 9.

If necessary, another heater-installed duct is provided at an appropriate location between the processing apparatus 101 and the trap device 100b. In this way, by-products can be prevented from adhering to the inner walls of the ducts forming the gas flow path between the processing apparatus 101 and the trap device 100b.

Then, the waste gas introduced in the trap device 100b flows into the heater-installed duct 2 through the cylindrical outer wall 10a. The waste gas is directly heated by the heater unit 11 in the gas flow path inside the heater-installed duct 2, and thereby is easily and efficiently heated to a predetermined temperature.

The waste gas heated as described above flows from the open end 15 of the duct 2 into the rotary tool 25 of the flow path selector switch 21 through the gas inlet 22 of the flow path selector switch 21. In this process, the heated waste gas continuously supplies thermal energy to the inside of the rotary tool 25. For this reason, the temperature of the waste gas does not drop to a temperature at which by-products can be produced. Only the minimum temperature margin needs to be set.

Then, the waste gas passes through the second vent hole 26, immediately flows out of the first vent hole 24, and flows into the first gas flow path 35. Further, the waste gas is conducted to a gas inlet 37 of the trap 1 through the first gas flow path 35. In this process, the inner wall of the gas-conducting pipe 36 is also heated by the waste gas flowing in the first gas flow path 35. For this reason, until the waste gas reaches the inside of the trap 1, the temperature of the waste gas does not drop to a temperature at which by-products can be produced. Only the minimum temperature margin needs to be set. This may prevent by-products from adhering to the inner wall of the gas-conducting pipe with no heater from the flow path selector switch 21 to the inside of the trap 1.

Next, the waste gas flowing into the trap 1 from the gas inlet 37 is cooled, and thereby by-products of the waste gas are generated and captured. Thus, the waste gas from which the by-products are sufficiently removed is discharged from the trap 1.

While this treatment is repeated, the byproducts cumulatively adhere to the adsorbent sheets inside the trap 1. Then, when a large amount of by-products thus increased causes stagnation of the waste gas flow in the trap 1 or has an adverse influence over the pump performance due to a large pressure loss, the entire trap 1 is replaced.

In this case, the gas to be discharged from the processing apparatus is switched from the waste gas to an inert gas to purge the remaining waste gas. After that, as illustrated in FIGS. 8 and 9, the rotary shaft 31 of the flow path selector switch 21 is rotated to set the flow path of the flow path selector switch 21 to the second gas flow path 32a which conducts the inert gas to a gas discharge side. In other words, the second vent hole 26 is unmated from the first vent hole 24, while the third vent hole 28 is mated to the fourth vent hole 30. In this case, it does not matter whether or not to supply electric power to the heater unit 11 in the duct 2.

In this state, the gas flow to the trap device 100b is also formed by the pump 9 and the inert gas discharged from the processing apparatus 101 is introduced into the trap device 100b from the gas inlet 3.

The inert gas introduced in the trap device 100b is discharged after flowing through the heater-installed duct 2 and the flow path selector switch 21, and then flowing through the second gas flow path 32a in the gas-conducting pipe 32 from the first gas flow path 35 without flowing into the trap 1.

Under this condition, the trap 1 is replaced.

Alternatively, a standby trap having the same structure as the trap 1 of the trap device 100b may be connected to the second gas flow path 32a, and be made ready for use when the flow path selector switch 21 switches the flow path from the first gas flow path 35 to the second gas flow path 32a. With this structure, the trap 1 can be replaced while the processing interruption in the processing apparatus 101 is minimized.

After the replacement with the new trap 1, the flow path is again switched to the first gas flow path 35 and thereby is returned into the state as illustrated in FIGS. 6 and 7. Thus, by-products can be removed from the waste gas after use.

Instead of the above case, the standby trap may be continuously used even after the replacement with the new trap 1. In this case, when the performance of the standby trap becomes poor, the flow path selector switch 21 again switches the waste gas flow path to the first gas flow path 35 and the new trap 1 is used.

As described above, the trap device 100b of the second modified embodiment is capable of capturing and removing by-products from the waste gas while retarding clogging of the waste gas flow path with the by-products.

In addition, since only a part (the trap 1) of the trap device 100b is replaced, the cost can be reduced.

### (5) Modified Embodiment of Flow Path Selector Switch (Communication Member) in FIGS. 6 and 8

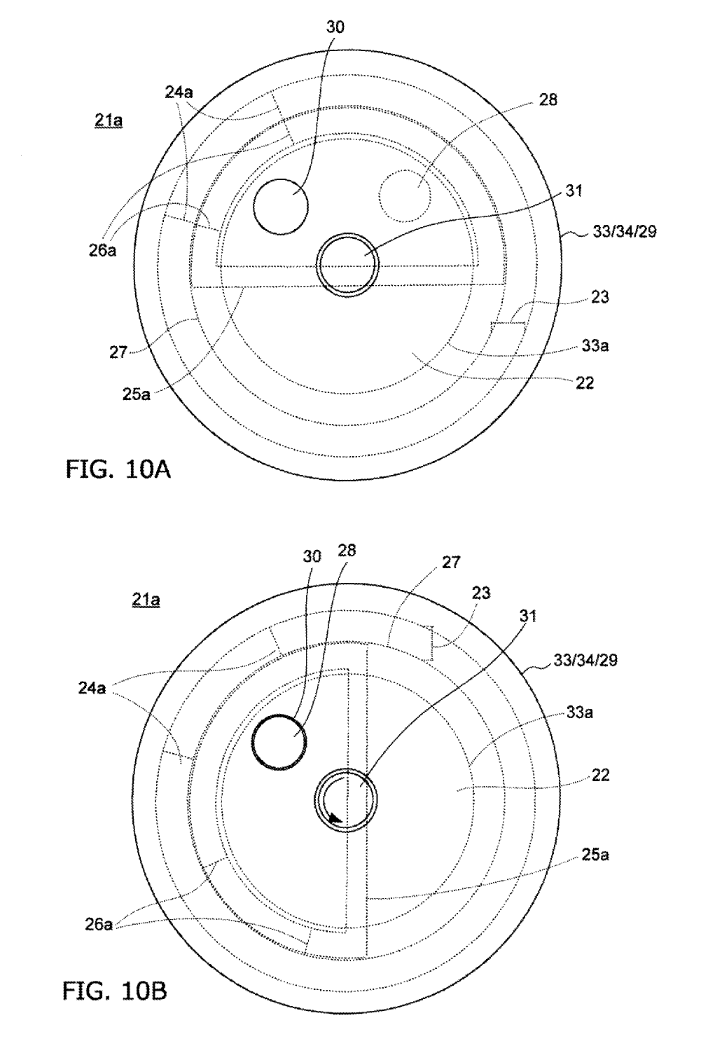

Next, a modified embodiment of the flow path selector switch in FIGS. 6 and 8 is described with reference to FIGS. 10A and 10B.

FIG. 10A is an enlarged upper side view illustrating the modified embodiment of the flow path selector switch in FIGS. 6 and 8. FIG. 10B is an enlarged upper side view illustrating a state where the flow path is switched by operating a rotary shaft 31 of a flow path selector switch 21a in FIG. 10A.

The flow path selector switch 21a according to the modified embodiment is different from the flow path selector switch 21 in FIGS. 6 and 8 in that a rotary tool 25a has a semi-cylindrical shape.

In FIGS. 10A and 10B, reference sign 24a indicates a first vent hole, and the first vent hole 24a is equivalent to the first vent hole 24 provided at the side surface of the cylindrical outer wall 23 in FIG. 6. Then, reference sign 26a indicates a second vent hole, and the second vent hole 26a is equivalent to the second vent hole 26 which is provided at the side surface of the cylindrical rotary tool 25 in FIG. 6 and which is mated to the first vent hole 24 with rotation of the rotary tool 25.

A disc-shaped first cover member 27 is provided on the upper end of the rotary tool 25a. The first cover member 27 covers an upper open end of the semi-cylindrical rotary tool 25a, closes an upper open end of the cylindrical outer wall 23, and rotates together with the rotary tool 25a. An outer rim of the first cover member 27 and an inner rim of the flange 34 are provided in close proximity to each other. Thus, the waste gas is inhibited from flowing through the clearance between the flange 34 and the first cover member 27 as in FIGS. 6 to 9.

In FIGS. 10A and 10B, the other elements that are the same as those indicated by reference signs in the FIGS. 6 to 9 are assigned with the same reference signs.

In FIG. 10A, the rotary shaft 31 of the flow path selector switch 21a is rotated to set the flow path of the flow path selector switch 21a in a state of diverting the waste gas discharged from the heater-installed duct 2 to the first gas flow path 35 leading to the trap 1. In other words, the second vent hole 26a is mated to the first vent hole 24a, while the third vent hole 28 is unmated from the fourth vent hole 30.

In FIG. 10B, the rotary shaft 31 of the flow path selector switch 21a is rotated to switch the flow path of the flow path selector switch 21a to the second gas flow path 32a which conducts the inert gas to the gas discharge side. In other words, the second vent hole 26a is unmated from the first vent hole 24a, while the third vent hole 28 is mated to the fourth vent hole 30.

With this structure, the trap device including the flow path selector switch 21a according to the modified embodiment is also capable of capturing and removing by-products from the waste gas while retarding clogging of the waste gas flow path with the by-products as in the trap device 100b of the second modified embodiment.

In addition, the switching of the flow path by the flow path selector switch 21a allows the trap 1 to be replaced with a new one within the shortest period of time.

### (6) Third Modified Embodiment of Trap Device in FIG. 5

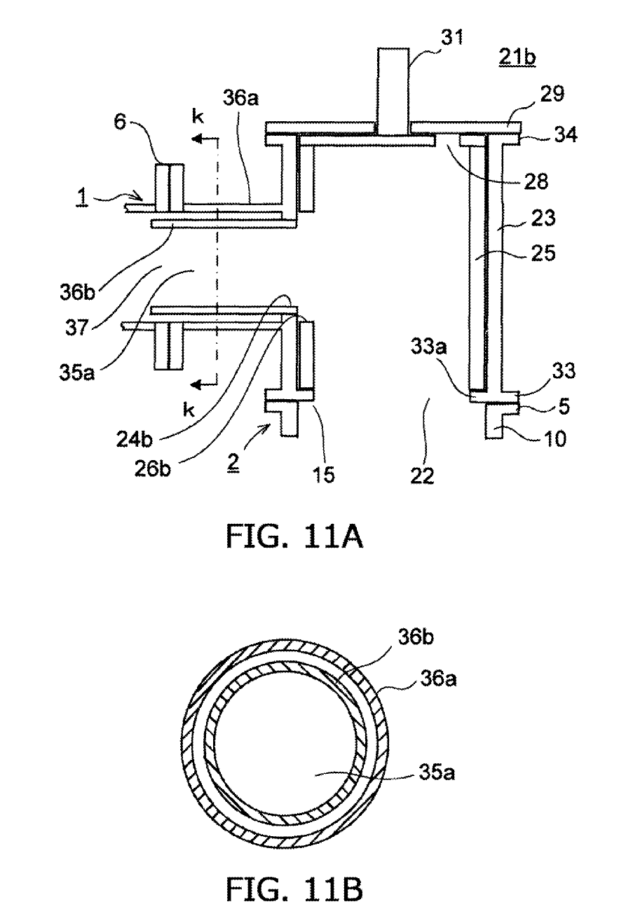

FIG. 11A is a cross sectional view illustrating a third modified embodiment of the trap device 100b in FIG. 5 and corresponding to the FIG. 7A, and FIG. 11B is a cross sectional view taken along a k-k line in FIG. 11A.

In the third modified embodiment, in place of the gas-conducting pipe 36 in FIG. 7A, double gas-conducting pipes including a cylindrical outer pipe 36a and a cylindrical inner pipe 36b provided inside the outer pipe 36a concentrically with the outer pipe 36a are used as a gas-conducting pipe connecting a flow path selector switch 21b and the trap 1, as illustrated in FIGS. 11A and 11B.

A first gas flow path 35a is formed inside the inner pipe 36b, and a diameter of a first vent hole 24b is determined according to an inner diameter of the inner pipe 36b. Thus, the first gas flow path 35a is connected to the first vent hole 24b and the first vent hole 24b is connected through the first gas flow path 35a to the gas inlet 37 provided in the trap 1.

The inner pipe 36b is kept out of contact with the flange 6 of the trap 1 and the outer pipe 36a as far as possible. The inner pipe 36b is made of an adiabatic material, for example, Teflon (registered trademark).

In FIGS. 11A and 11B, elements indicated by the same reference signs as the reference signs in the FIG. 7A are the same elements as in FIG. 7A.

As described above, in the trap device of the third modified embodiment, the first gas flow path 35a connecting the flow path selector switch 21b and the trap 1 is thermally insulated from the outside air by two means, namely, the structure and the material, and is also thermally insulated from the trap 1 which is cooled for use.

In other words, the third modified embodiment employs the structure in which the waste gas after use flowing in the first gas flow path 35a is hardly cooled.

Therefore, the trap device of the third modified embodiment is capable of capturing and removing by-products from the waste gas while further retarding clogging of the waste gas flow path with the by-products.

In the embodiment, the heater is placed in the waste gas flow path inside the duct and directly heats the waste gas, and this structure makes the function of the double pipe structure much more effective than a structure of heating the waste gas from the outside of the duct. Specifically, if the flow path were heated from the outside of the outer pipe 36a, the flow path would be heated through the inner pipe 36b in addition to the outer pipe 36a and the heating efficiency would be very poor.

### (Structure of Trap 1 in FIGS. 1, 4, and 5)

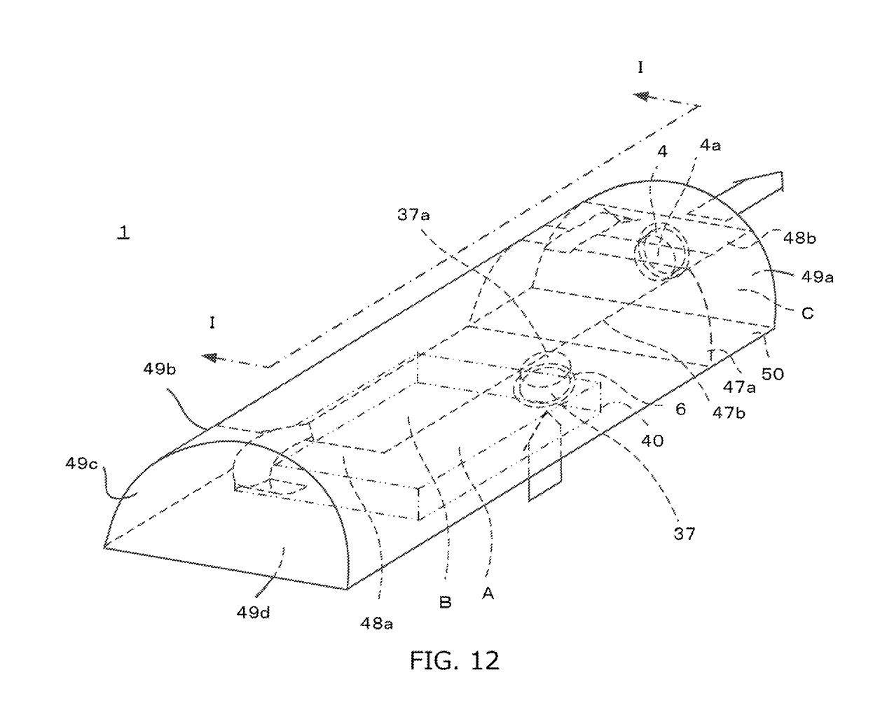

FIGS. 12 to 15 are drawings for explaining the structure of the trap in the trap device according to the embodiment.

FIG. 12 is a perspective view illustrating the entire structure of the horizontal trap 1 illustrated in FIGS. 1, 4, and 5.

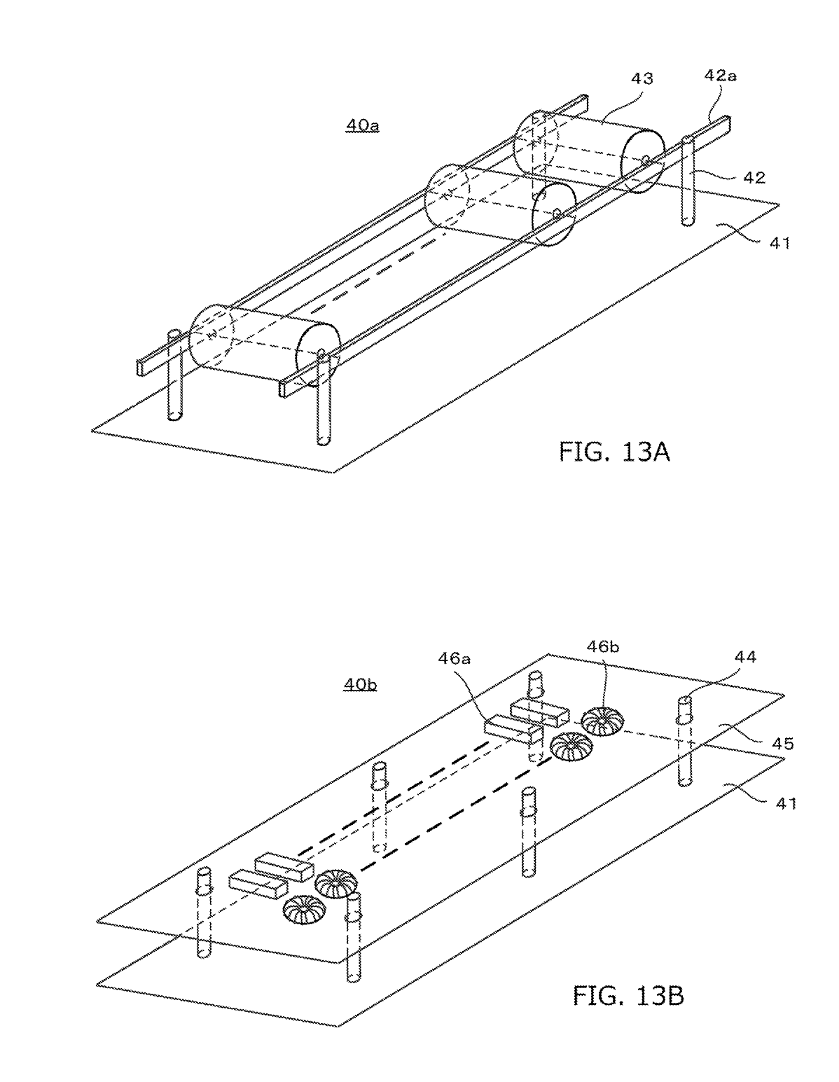

FIGS. 13A and 13B illustrate capture members 40a, 40b installed in the trap 1 and layouts of capture bodies 43, 46a, 46b included in the capture members 40a, 40b. Each of the capture members 40a, 40b cools the waste gas and captures by-products generated from the waste gas by cooling the waste gas.

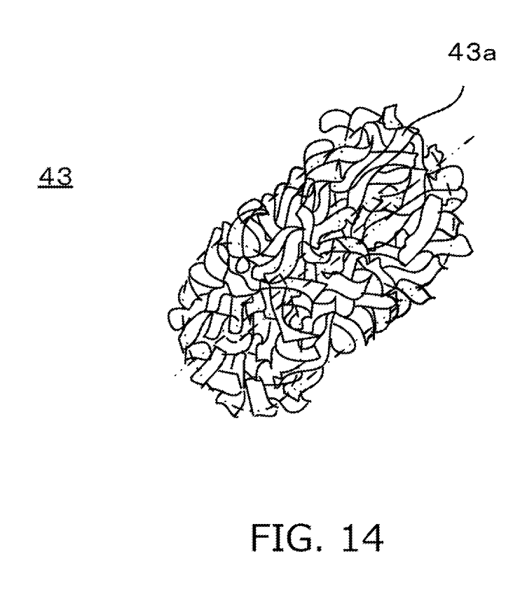

FIG. 14 is a perspective view more specifically illustrating a part of the cylindrical capture body 43 illustrated in FIG. 13A.

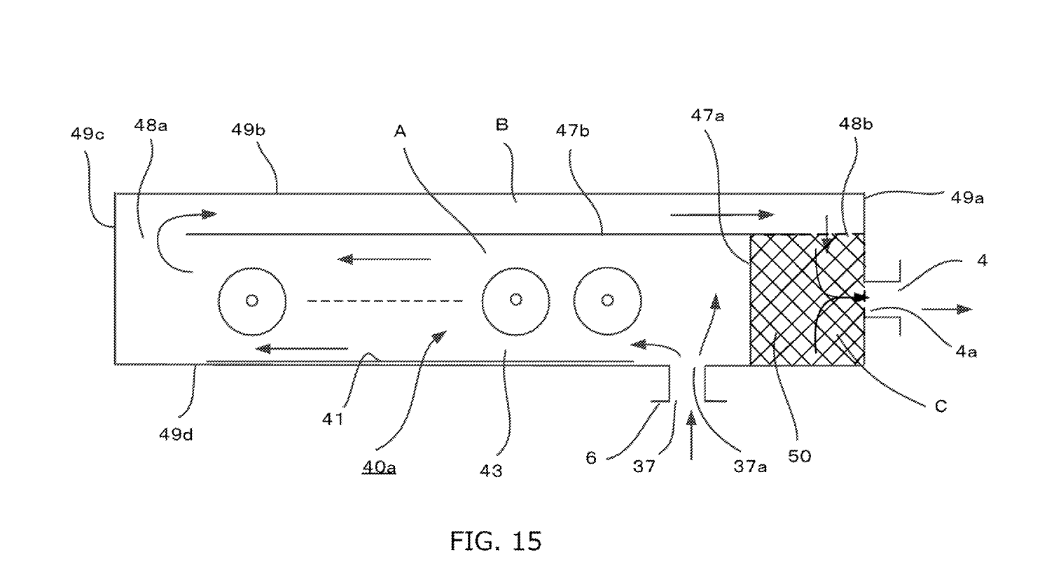

FIG. 15 is a cross sectional view taken along a I-I line in FIG. 12. The capture member 40a illustrated in FIG. 13A is used as the capture member 40.

In FIGS. 12 to 15, elements indicated by the same reference signs as in FIGS. 1 to 11 are the same elements as in FIGS. 1 to 11.

As illustrated in FIG. 12, the trap 1 has a semi-cylindrical housing. The housing includes a flat housing wall 49d serving as a bottom, a semi-cylindrical housing wall 49b arranged on the housing wall 49d, and housing walls 49a, 49c arranged at both ends of the housing wall 49b.

The housing wall 49d has a flat surface extending in a longitudinal direction of the trap 1. The housing wall 49b is formed of a semi-cylindrical plate having the same length as the housing wall 49d, and extending in the longitudinal direction of the trap 1. The housing walls 49a, 49c have flat surfaces in a semi-circle shape, and are opposed to each other in the longitudinal direction of the trap 1. The housing walls 49a, 49b, 49c, and 49d are made of metal plates, for example, stainless steel plates.

A gas inlet 37a is provided in the bottom housing wall 49d, and a gas outlet 4a is provided in the housing wall 49a on one end side of the housing.

In the trap 1, as illustrated in FIGS. 12 and 15, the waste gas introduced from the gas inlet 37a flows to the gas outlet 4a while passing a chamber A (gas introduction chamber), a flow path B (gas flow path), and a chamber C (gas outgoing chamber (also serving as a gas flow path)) in this order.

The gas transfers from the chamber A to the flow path B through a vent hole 48a provided in a partition 47b at a location close to the housing wall 49c on the other end side of the housing. The gas transfers from the flow path B to the chamber C through a vent hole 48b provided in the partition 47b at a location close to the housing wall 49a on the one end side of the housing.

The chamber A includes the gas inlet 37a. The chamber A is separated from the flow path B by the partition 47b arranged in parallel with the flat surface of the housing wall 49d, and is separated from the chamber C by a partition 47a extending vertically from the partition 47b. In other words, the chamber A is formed of a space on the housing wall 49d side demarcated by the partitions 47a and 47b. The gas inlet 37a is provided close to the partition 47a near the housing wall 49a on the one end side.

Here, the trap 1 is required to have functions to keep by-products from being generated from the waste gas before the waste gas enters the chamber A of the trap 1, and to generate by-products after the waste gas enters the chamber A.

In the trap device of the embodiment, the waste gas is heated to a high temperature by the heater immediately before the gas inlet 37 of the trap 1. For this reason, while flowing from the gas inlet 37 of the trap 1 to the gas inlet 37a of the chamber A, the waste gas also heats its surroundings and therefore a drop in temperature is suppressed. If necessary, the minimum temperature margin may be set so as not to generate by-products before the gas is introduced into the chamber A.

On the other hand, after the waste gas is introduced into the chamber A, the waste gas needs to be rapidly expanded to cause a sufficient drop in temperature. To this end, it is desirable to allocate a sufficiently large space to the chamber A.

From the viewpoint of downsizing of the trap 1, however, it is sometimes difficult to allocate a sufficiently large space to the chamber A. In this case, the trap 1 needs to cause a sufficient drop in temperature by compensating for an insufficient drop in temperature. With this purpose, in the trap 1, the chamber A is configured to allow the capture member 40a including multiple capture bodies 43 to be installed between the gas inlet 37a and the vent hole 48a.

For example, each capture body 43 has a diameter of about 50 mm and a length of about 180 mm. The capture member 40a is formed of about five lines of the capture bodies 43 arranged along the waste gas flow at intervals of 50 to 100 mm. The dimensions of the capture body 43 may be changed as appropriate, and the number of lines of the capture bodies 43 may be changed as appropriate depending on the size of the chamber A so as to cause a sufficient drop in temperature of the waste gas. In addition, instead of including one capture body 43, one line may include multiple short capture bodies 43 arranged side by side.

As illustrated in FIG. 14, each capture body 43 is formed of a bundle of a large number of slender and flexible plate-like members (including foil-like members) or rod-like members 43a made of a metal, for example, stainless steel, or a bundle of a large number of metal coils. The bundle is formed in a columnar or cylindrical shape. Clearances which allow gas passage are preferably formed between the metal plates or metal foils 43a. Here, the capture body 43 is made of the metal, but may be made of another material. A glass wool or any other material suitable for adsorption of by-products may be used if the waste gas can be cooled sufficiently.

Moreover, both ends of each of the columnar or cylindrical capture bodies 43 are supported by a pair of support plates 42a. Then, each of the support plates 42a is supported at both ends by support rods 42 and the support rods 42 are fixed to a support base 41 made of stainless steel.

As illustrated in FIGS. 13 and 15, the capture bodies 43 are arranged along a waste gas flow direction at the same height with longitudinal sides of the capture bodies 43 opposed to the waste gas flow.

Here, all the capture bodies 43 do not have to be arranged at the same height, but the capture bodies 43 may be arranged at different heights as appropriate. For example, the heights of the capture bodies 43 are preferably adjusted such that the capture bodies 43 can efficiently cool the waste gas passing the capture bodies 43. In this case, instead of using the support plates 42a, a pair of support rods 42 may be used for each capture body 43.

Meanwhile, the capture member 40b has another structure illustrated in FIG. 13B.

In the other capture member 40b, six support rods 44 are provided to stand on a surface of a support base 41 in such a way that each of four support rods 44 is fixed at one end to each of four corner portions on the surface and each of two support rods 44 is fixed at one end to each of two side center portions on the surface. A single mesh-like or porous metal tier plate 45 is attached to the other ends of the six support rods 44.

Then, the capture bodies 46a and 46b are mounted on a surface of the tier plate 45. As illustrated in FIG. 14, a capture body 46a is formed of a bundle of a large number of slender and flexible plate-like members (including foil-like members) or rod-like members 43a made of a metal, for example, stainless steel. The bundle is formed in a columnar or cylindrical shape. A capture body 46 is formed of a bundle of a large number of metal coils not illustrated. The bundle is formed in a bar-like or doughnut-like shape. The capture body 46a has, for example, a height of about 30 mm and a length of about 60 mm, while the capture body 46b has, for example, a height of about 30 mm and a diameter of 40 to 50 mm.

Here, the capture bodies mounted on the surface of the tier plate 45 do not have to be both types of the capture bodies 46a and 46b, but may be of any one type of them. Moreover, the capture body 46a, 46b is made of the metal, but may be made of another material. A glass wool or any other material suitable for adsorption of by-products may be used if the waste gas can be cooled sufficiently.

The flow path B is formed of a space on a semi-cylindrical upper side demarcated by the semi-cylindrical housing wall 49b and the partition 47b.

The chamber C is directly connected to the gas outlet 4a. The partition 47b is extended to the housing wall 49a beyond the partition 47a. The chamber C is formed by the extended partition 47b, the partition 47a, and the housing wall 49a.

In addition, in order to capture by-products generated from the waste gas before the waste gas reaches the chamber C and by-products newly generated in the chamber C, a capture member 50 made of, for example, a glass wool is installed in the chamber C. In some cases, as the capture member 50, the metal capture bodies 43 as illustrated in FIG. 14 may be placed in place of the glass wool capture member 50 or together with the glass wool capture member 50.

Next, description is provided for a waste gas flow in the trap 1 and how to remove by-products in the trap 1.

The waste gas immediately before the introduction to the chamber A from the gas inlet 37a is heated by the heater. The high-temperature waste gas introduced into the chamber A is rapidly expanded in the chamber A to cause a drop in temperature.

In the chamber A, the trap 1 causes a drop in temperature of the waste gas and thereby generates by-products from the waste gas. Here, if the by-products are apt to adhere to other objects, the by-products adhere to the capture bodies 43 and the inner walls of the trap 1 and thereby are removed from the waste gas. If the by-products are unapt to adhere to the other objects, the by-products fall onto the housing wall 49d forming the bottom of the chamber A and thereby are removed from the waste gas.

Subsequently, the waste gas transfers to the flow path B, further causes a drop in temperature while passing the flow path B, and reaches the chamber C. In this process, by-products newly generated in the flow path B and by-products transported from the chamber A to the flow path B fall and are deposited on the surface of the partition 47b.

In the chamber C, the waste gas is further cooled by the capture member 50, and by-products generated in the chamber A and the flow path B and transported to the chamber C while remaining unremoved in the chamber A and the flow path B and by-products newly generated in the chamber C are captured and removed from the waste gas by the capture member 50.

In the trap device of the embodiment, the waste gas is heated to a high temperature by the heater in the duct immediately before the inlet of the trap 1. In addition, since the fins 17 are provided around the outer circumference of the heater in the duct, the flowing waste gas is disturbed by the fins 17 and thereby has good temperature uniformity. Hence, the waste gas undergoes only a small change in temperature while passing the trap inlet.

This structure can minimize a drop in temperature of the waste gas flowing through the gas introduction path from the gas inlet 37 of the trap 1 to the gas inlet 37a of the chamber A (hereinafter referred to as the gas introduction path 37 to 37a in some cases), and prevent by-products from being generated from the flowing waste gas and adhering to the gas introduction path 37 to 37a.

In addition, the chamber A includes the gas inlet 37a, and the chamber A is surrounded by the partitions 47a and 47b. This structure isolates the chamber A from the gas outlet 4a and therefore is capable of preventing the waste gas, which has just entered the chamber A from the gas inlet 37a and has a temperature yet to drop sufficiently, from flowing out of the gas outlet 4a.

Moreover, the gas inlet 37a is arranged close to the partition 47a, the partition 47b is extended to a location near the housing wall 49c, and the vent hole 48a through which the waste gas transfers from the chamber A to the flow path B is provided close to the housing wall 49c. With this structure, the capacity of the chamber A can be made as large as possible so as to expand the waste gas to achieve a sufficient drop in temperature of the waste gas.

Moreover, even in the case where it is difficult to make the capacity of the chamber A sufficiently large from the viewpoint of downsizing of the device, the structure in which the metal capture member 40 is installed between the gas inlet 37a and the vent hole 48a in the chamber A enables a sufficient drop in temperature of the waste gas by rapidly expanding the waste gas and bringing the waste gas into contact with the metal capture member 40.

As described above, even when the high-temperature waste gas enters the trap, the trap is capable of effectively cooling the waste gas inside the trap and thereby generating and removing by-products from the waste gas, while preventing by-products from adhering to the gas introduction path 37 to 37a.

In FIGS. 12 and 15, the chamber C is provided downstream of the flow path B.

Alternatively, the chamber C may be unemployed and the flow path B may be directly connected to the gas outlet. The same goes for the following modified embodiments.

### Fourth Modified Embodiment of Trap Device 100b

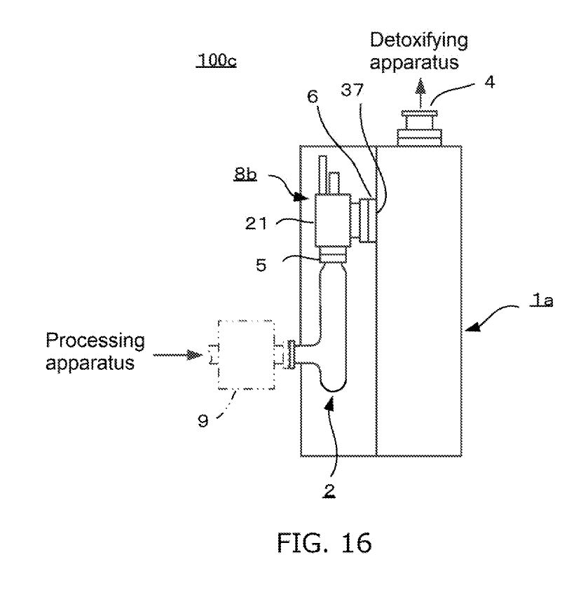

FIG. 16 is a side view illustrating a fourth modified embodiment of the trap device 100b in FIG. 5.

A trap device 100c in FIG. 16 is different from the trap device 100b in FIG. 5 in that the trap device 100c includes a vertical trap, whereas the trap device 100b in FIG. 5 includes a horizontal trap. Accordingly, the trap device 100c has a structure suitably changed for the vertical trap from the structure for the horizontal trap 1 in FIGS. 12 to 15.

In FIG. 16, elements indicated by the same reference signs as in FIGS. 1 to 11 are the same elements as in FIGS. 1 to 11.

### (Structure of Trap 1a)

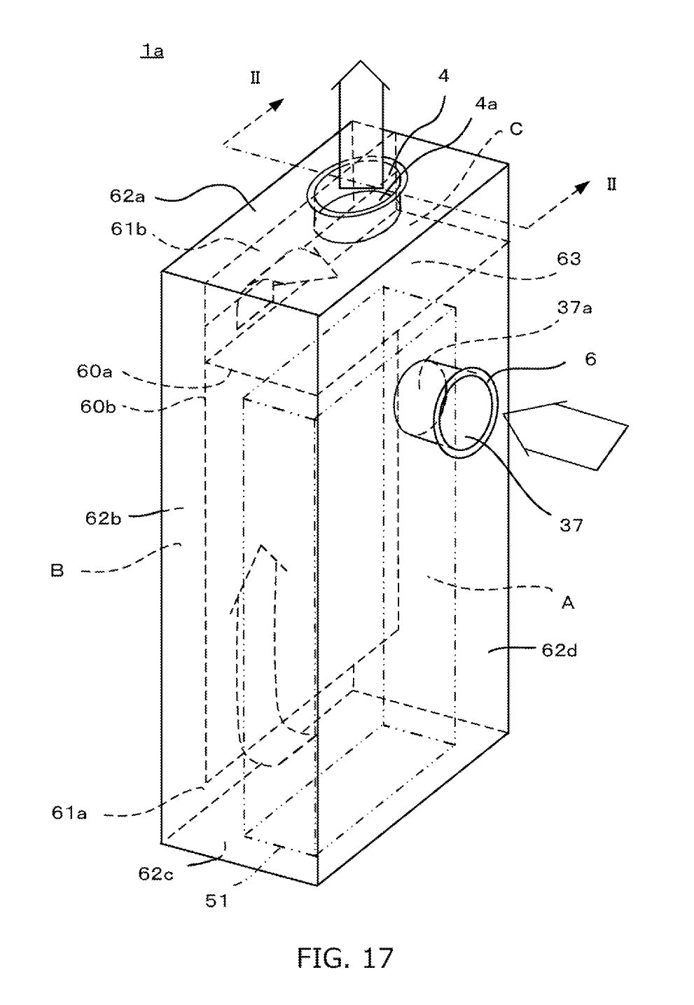

FIGS. 17 to 20 are views for explaining a structure of a trap 1a in the trap device 100c according to the embodiment.

FIG. 17 is a perspective view illustrating a structure of the trap 1a in FIG. 16.

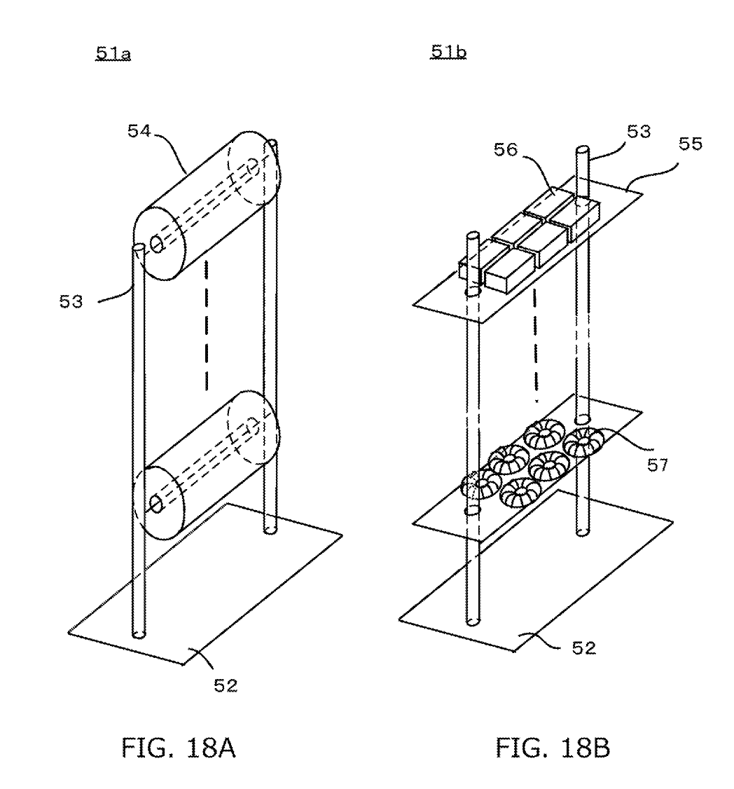

FIGS. 18A and 18B are perspective views illustrating two types of specific structures of a capture member 51 in FIG. 17.

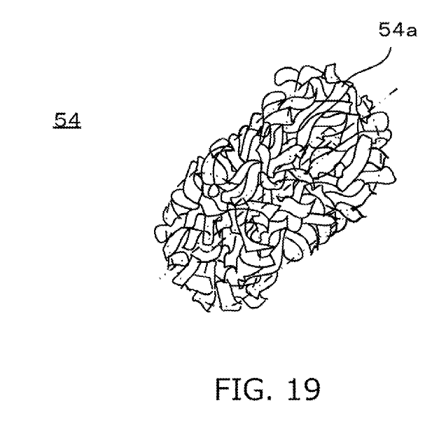

FIG. 19 is a perspective view illustrating a specific structure of a capture body 54.

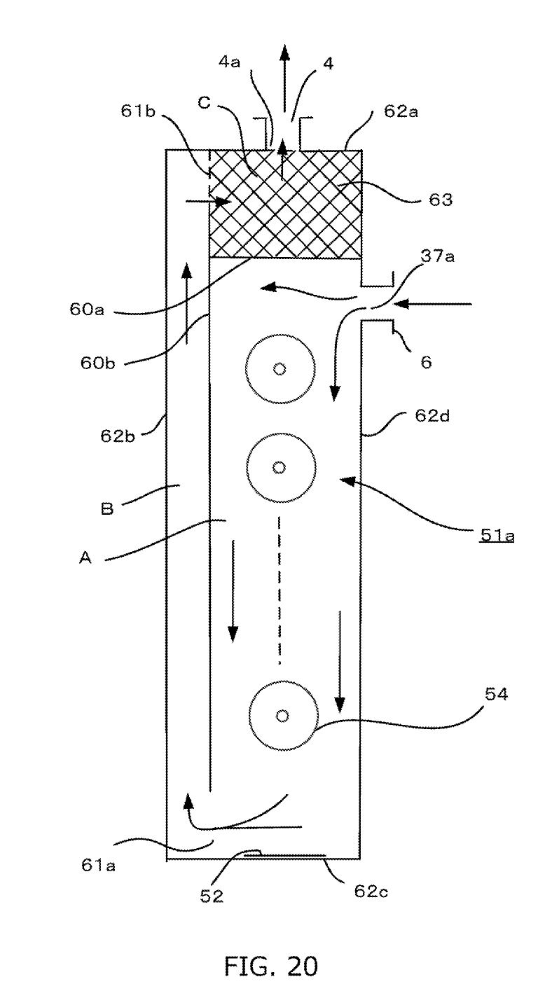

FIG. 20 is a cross sectional view of the trap 1a taken along a II-II line in FIG. 17.

The trap 1a in FIGS. 17 and 20 is different from the trap 1 in FIG. 12 in the following points.

First, the trap 1 in FIG. 12 includes the housing in the semi-cylindrical shape, whereas the trap 1a includes a housing in a rectangular parallelepiped or box shape as illustrated in FIG. 17. The outer dimensions of this housing are, for example, a height of 950 mm, a width of 280 mm, and a depth of 130 mm, and has a capacity of 34,580 cm³ including plate thicknesses of wall materials.

The housing includes housing walls 62b, 62b, 62b, 62d forming four side surfaces, a housing wall 62a forming an upper surface, and a housing wall 62c forming a bottom surface.

Here, a waste gas flow direction is set to the vertical direction. Specifically, in the chamber A provided with the gas inlet 37a, the gas inlet 37a is arranged at an upper portion of the chamber A close to a partition 60a, and the waste gas after entering the chamber A from the gas inlet 37a flows downward from the upper portion of the chamber A. In the flow path B, the waste gas coming from a lower portion of the chamber A flows upward from the lower portion. The chamber C is provided with the gas outlet 4a and the gas coming from the flow path B in a horizontal direction flows further upward and flows out of the gas outlet 4a.

Then, in the capture member 51, multiple capture bodies 54 are arrayed in the vertical direction so as to align along the gas flow in FIG. 18A. In FIG. 18B, multiple tier plates 55 made of a metal, for example, stainless steel are arrayed in the vertical direction so as to align along the gas flow.

The chamber A is separated from the flow path B by an internal partition 60b arranged in parallel with the flat surface of the housing wall 62d, and is separated from the chamber C by the partition 60a extending horizontally from the partition 60b. In other words, the chamber A is formed of a space on the housing wall 62d side demarcated by the partitions 60a and 60b.

In the trap 1a, as illustrated in FIG. 18A, a capture member 51a including multiple capture bodies 54 is installed in the chamber A.

Each capture body 54 is formed of a bundle of a large number of slender and flexible plate-like members (including foil-like members) or rod-like members 54a made of a metal, for example, stainless steel, or a bundle of a large number of metal coils not illustrated. The bundle is formed in a columnar or cylindrical shape. Clearances which allow gas passage are preferably formed between the metal plates or metal foils 54a. Here, the capture body 54 is made of the metal, but may be made of another material. A glass wool or any other material suitable for adsorption of by-products may be used if the waste gas can be cooled sufficiently.

For example, each capture body 54 has a diameter of about 50 mm and a length of about 180 mm. The capture member 51a is formed of about five to eight lines of the capture bodies 54 arranged at intervals of 50 to 100 mm. The number of lines of the capture bodies 54 may be changed as appropriate depending on the size of the chamber A so as to cause a sufficient drop in temperature of the waste gas.

Moreover, both ends of the columnar or cylindrical capture bodies 54 are held by a pair of support rods 53 made of a metal, for example, stainless steel in such a way that the capture bodies 54 are arrayed in the vertical direction. Then, the other ends of the pair of support rods 53 supporting all the capture bodies 54 are both fixed to a support base 52 made of stainless steel.

As illustrated in FIG. 20, each capture body 54 is arranged to be opposed to the waste gas flow. All the multiple capture bodies 54 do not have to be supported by the same pair of support rods 53. For example, some of the capture bodies 54 may be shifted to locations close to the housing wall 62d or the partition 60b and supported by a different pair of support rods. For example, the layout of the multiple capture bodies 54 is preferably adjusted such that the capture bodies 54 can efficiently cool the waste gas passing the capture bodies 54.

Meanwhile, the capture member 51b has another structure illustrated in FIG. 18B.

The other capture member 51b uses a support base 52 to which one pair of support rods 53 is fixed, and multiple mesh-like or porous metal tier plates 55 are attached to the pair of support rods 53 so as to be arrayed in the vertical direction. For example, seven or eight tier plates 55 are arranged at intervals of about 100 mm.

Then, any one type or both types of capture bodies 56 and 57 are mounted on the surface of each of the tier plates 55. As illustrated in FIG. 19, each capture body 56, 57 is formed of a bundle of a large number of slender and flexible plate-like members (including foil-like members) or rod-like members 54a, for example, strip-shaped metal thin plates or metal foils, or a bundle of a large number of metal coils not illustrated. The bundle is formed in a bar-like or doughnut-like shape. The capture body 56 has, for example, a height of about 30 mm and a length of about 60 mm, while the capture body 57 has, for example, a height of about 30 mm and a diameter of 40 to 50 mm.

Here, the capture body 56, 57 is made of the metal, but may be made of another material. In the latter case, a glass wool or any other material suitable for adsorption of by-products may be also used if the waste gas can be cooled sufficiently.

The flow path B is formed of a rectangular parallelepiped space with a narrow depth formed by the housing walls 62b forming the side surfaces of the housing, and the partition 60b extended to the housing wall 62c forming the bottom surface of the housing. The gas transfers from the chamber A to the flow path B through a vent hole 61a provided in the partition 60b at a location close to the housing wall 62c. By-products generated in the flow path B and by-products transported from the chamber A to the flow path B fall and accumulate onto the bottom surface of the housing.

As for the chamber C, the partition 60b is extended beyond the partition 60a to the housing wall 62a forming the upper surface of the housing. The chamber C is formed by the extended partition 60b, the partition 60a horizontally extended, and the housing wall 62a.

The gas transfers from the flow path B to the chamber C through a vent hole 61b provided in the partition 60b at a location close to the housing wall 62a.

In addition, in order to capture by-products previously generated or by-products newly generated from the waste gas in the chamber C, a capture member 63 made of, for example, a glass wool is installed in the chamber C. In some cases, as the capture member 63, the metal capture bodies 54 as illustrated in FIG. 19 may be placed in place of the glass wool capture member 63 or together with the glass wool capture member 63.

Next, description is provided for a waste gas flow in the trap 1a and how to remove by-products in the trap 1a.

The waste gas immediately before the introduction to the chamber A from the gas inlet 37a has a high temperature because the waste gas is heated by the heater. The high-temperature waste gas introduced into the chamber A is rapidly expanded in the chamber A to cause a drop in temperature of the waste gas.

In the chamber A, the trap 1a causes a drop in temperature of the waste gas and thereby generates by-products from the waste gas. Here, if the by-products are apt to adhere to other objects, the by-products adhere to the capture bodies 54 and the inner walls of the trap 1a and thereby are removed from the waste gas. If the by-products are unapt to adhere to the other objects, the by-products fall onto the housing wall 62c forming the bottom of the chamber A and thereby are removed from the waste gas.

Subsequently, the waste gas transfers to the flow path B, further causes a drop in temperature while passing the flow path B, and reaches the chamber C. In this process, by-products newly generated in the flow path B and by-products transported from the chamber A to the flow path B fall and are deposited on the surface of the partition 62c.

In the chamber C, the waste gas is further cooled by the capture member 63, and by-products generated in the chamber A and the flow path B and transported to the chamber C while remaining unremoved in the chamber A and the flow path B and by-products newly generated in the chamber C are captured and removed from the waste gas by the capture member 63.

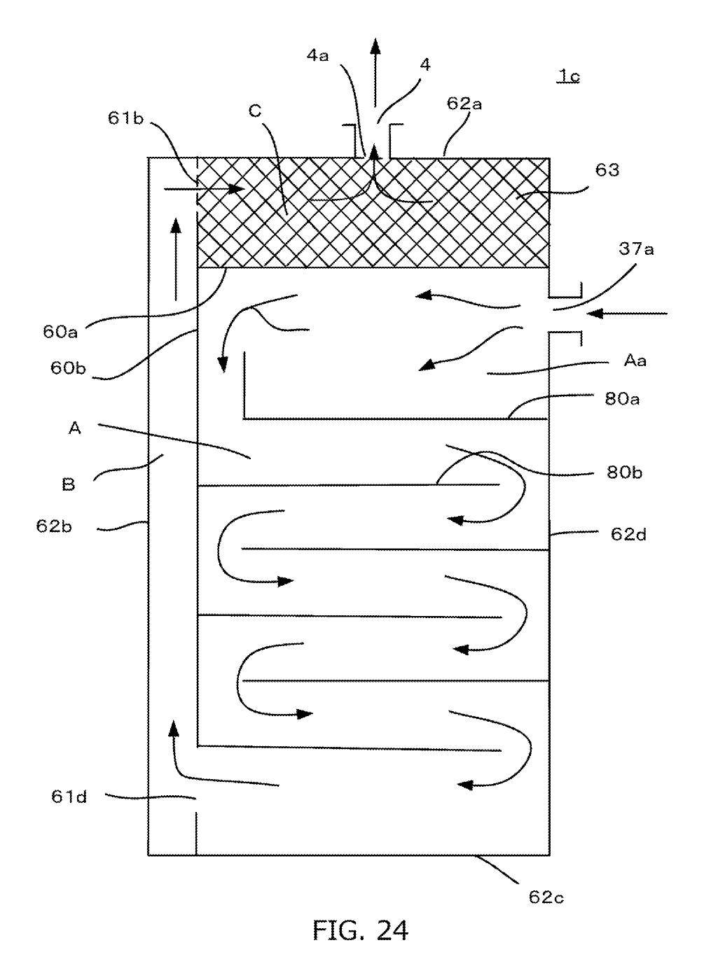

Using the above-described trap 1a, comparative experiment was carried out on a temperature drop performance (T(outlet)−T(inlet))/V(trap capacity)). Here, T(inlet) denotes a temperature of the waste gas at the inlet of the trap, and T(outlet) denotes a temperature of the waste gas at the outlet of the trap. As a comparative trap, a trap illustrated in FIG. 24 was used. The trap in FIG. 24 is provided with a gas introduction chamber (chamber A) in which the waste gas is adiabatically expanded in a section having a small capacity immediately after entering the chamber A, and flows through a zig-zag gas flow path in a major section.

In the trap 1a in FIG. 20, T(inlet) was about 160° C. and T(outlet) was about 40° C. when the flow rate was 20 l/min. Thus, the temperature drop performance was calculated as (40° C.−160° C.)/34,580 cm³=−3.47×10⁻³° C./cm³. Then, when the gas flow rate was 30 l/min, the temperature drop performance was calculated as (47° C.−154° C.)/34,580 cm³=−3.09×10⁻³° C./cm³. Note that this performance can be improved by further increasing the capture bodies 54, 56, 57.

Meanwhile, in the trap in FIG. 24, when the gas flow rate was 30 l/min, the temperature drop performance was calculated as (40° C.−120° C.)/51,975 cm³=−1.54×10⁻³° C./cm³.

As a result of the above comparative experiment, the performance of the trap 1a in FIG. 20 is about two times as high as the performance of the trap in FIG. 24.

As described above, in the trap device 100c of the embodiment, the waste gas is heated to a high temperature by the heater in the duct immediately before the inlet of the trap 1a. This structure can minimize a drop in temperature of the waste gas flowing through the gas introduction path from the gas inlet 37 of the trap 1a to the gas inlet 37a of the chamber A, and prevent by-products from being generated from the flowing waste gas and adhering to the gas introduction path 37 to 37a.

Moreover, since the fins 17 are provided around the outer circumference of the heater in the duct, the flowing waste gas is disturbed by the fins 17 and thereby has good temperature uniformity. Thus, the waste gas undergoes only a small change in temperature while passing the trap inlet. This allows the temperature margin (in other words, the electric power margin) to be reduced to the minimum possible, and enables more efficient power consumption.

In addition, the chamber A includes the gas inlet 37a, and the chamber A is surrounded by the partitions 60a and 60b. This structure isolates the chamber A from the gas outlet 4a and therefore is capable of preventing the waste gas, which has just entered the chamber A from the gas inlet 37a and has a temperature yet to drop sufficiently, from flowing toward the gas outlet 4a.

Moreover, the gas inlet 37a is arranged close to the gas outlet 4a in the upper portion of the trap 1a, the partition 60b is extended to the bottom surface of the housing, and the vent hole 61a through which the waste gas transfers from the chamber A to the flow path B is provided close to the bottom surface of the housing. With this structure, the capacity of the chamber A can be made as large as possible so as to expand the waste gas to achieve a sufficient drop in temperature of the waste gas. In addition, this enables improvement of the temperature drop performance and downsizing of the trap.

Additionally, the gas inlet 37a and the gas outlet 4a are both provided in the upper portion of the trap. Thus, even when by-products are deposited, the gas inlet 37a and the gas outlet 4a are prevented from being blocked by the by-product deposit.

Moreover, even in the case where it is difficult to make the capacity of the chamber A sufficiently large from the viewpoint of downsizing of the device or where the flow rate of the waste gas is high, the structure in which the metal capture member 51 is installed between the gas inlet 37a and the vent hole 61a in the chamber A enables a sufficient drop in temperature of the waste gas by rapidly expanding the waste gas and bringing the waste gas into contact with the metal capture member 51.

As described above, even when the high-temperature waste gas enters the trap, the trap is capable of effectively cooling the waste gas inside the trap and thereby generating and removing by-products from the waste gas, while preventing by-products from adhering to the gas introduction path 37 to 37a.

Further, since the trap is a vertical trap, all by-products having been generated and fallen in the chamber A and the flow path B are deposited on the bottom surface of the housing. This is also advantageous in that the cleaning is easy.

### Fifth Modified Embodiment of Trap Device 100b

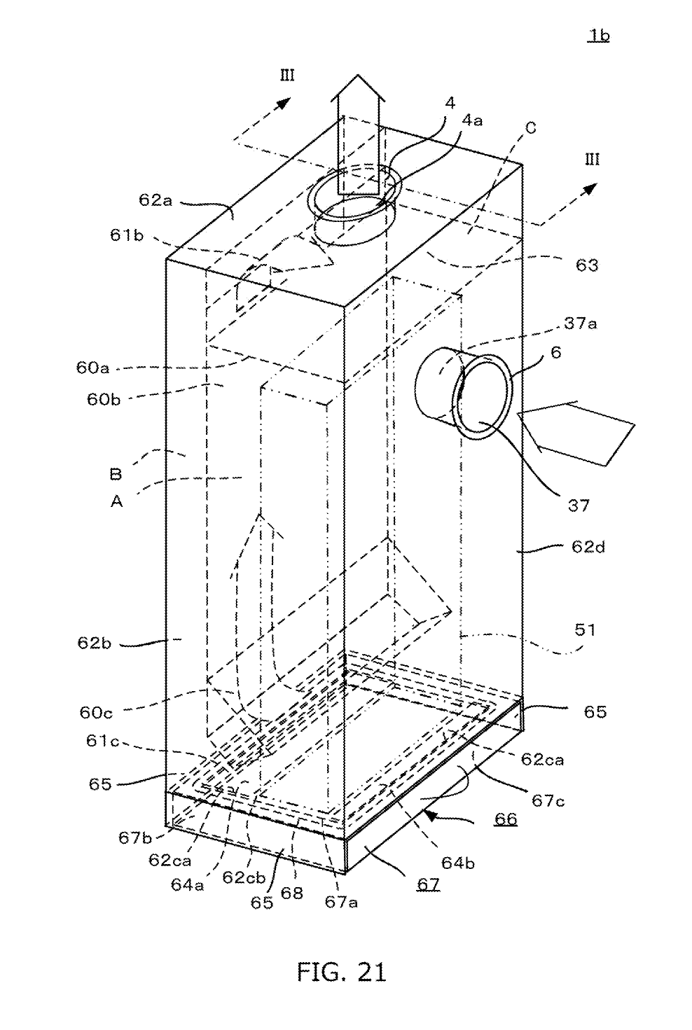

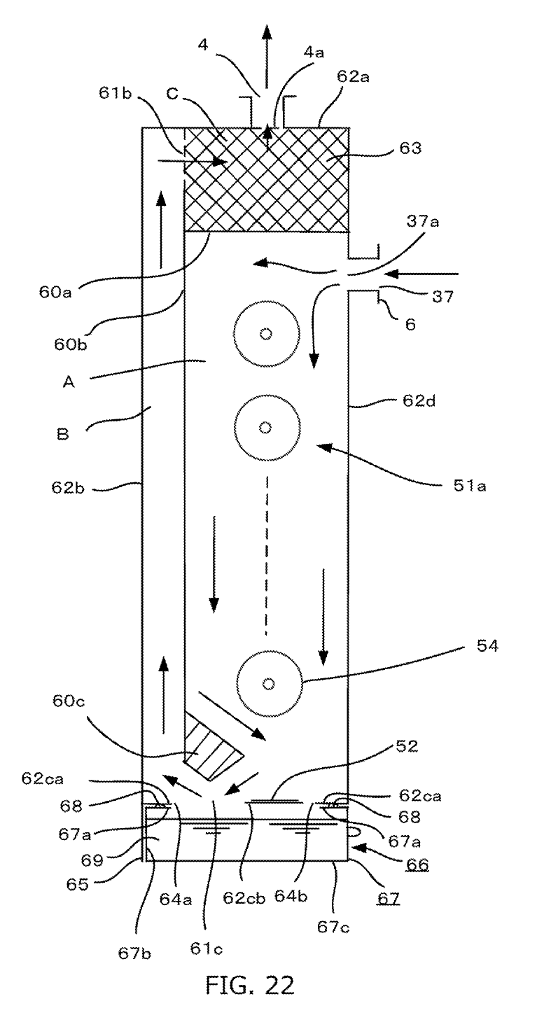

With reference to FIGS. 21 and 22, description is provided for a structure of a trap 1b obtained by further modification of the trap 1a FIGS. 17 and 20

FIG. 21 is a perspective view for explaining a structure of the trap 1b.

FIG. 22 is a cross sectional view of the trap 1b taken along a III-III line in FIG. 21. As a capture member 51, the capture member 51a illustrated in FIG. 18A is used.

As compared with the trap 1a in FIGS. 17 to 20, the trap 1b further includes a by-product capture unit 66 installed on the bottom of the chamber A. With the provision of the capture unit 66, the vent hole for the waste gas from the chamber A to the flow path B is also modified to form a new gas flow path 61c. Moreover, the depth of the housing is also made somewhat larger than that of the trap 1a in FIG. 17.

In FIGS. 21 and. 22, elements indicated by the same reference signs as the reference signs in the FIGS. 17 to 20 are the same elements as in FIGS. 17 to 20. In the following description, the structure of the capture unit 66 is mainly elaborated on.

In the trap 1b, as illustrated in FIGS. 21 and. 22, a drawer mechanism as the capture unit 66 is added to the bottom surface of the housing of the trap 1a. The drawer mechanism includes a drawer 67, frames 65 arranged along side surfaces of the drawer 67, and an upper frame 62ca arranged along an upper surface of the drawer 67. Here, the upper frame 62ca is formed by using the housing wall forming the bottom surface of the housing.

The frames 65 along the side surfaces are formed by using extended portions of any three of the four side housing walls 62b, 62b, 62b, and 62d of the housing. In this modified embodiment, the frames 65 include the extended portions of the three housing walls 62b, 62b, and 62b.

In order to store water 69, the drawer 67 is provided with a bottom plate 67c in the bottom surface, and also provided with frames 67b, forming four side surfaces, on edges of the bottom plate 67c. Whole upper ends of the frames 67b are fully provided with an upper frame 67a overhanging inward of the drawer 67 to some extent. Then, the upper surface of the upper frame 67a is provided with an elastic seal member 68 protruding upward from the upper surface. The upper surface of the drawer 67 excluding an area of the upper frame 67a is an opened area.

The upper frame 62ca formed by using the housing wall forming the bottom surface of the housing overhangs inward slightly more largely than the upper frame 67a of the drawer 67. This inhibits by-products from entering a clearance between the upper frame 67a of the drawer 67 and the upper frame 62ca.

Moreover, a mount plate 62cb where to mount the capture member 51 is provided integrally with the upper frame 62ca. The mount plate 62cb extends like a bridge connecting opposed portions of the upper frame 62ca. The bottom surface of the housing excluding portions of the upper frame 62ca and the mount plate 62cb is formed to be opened portions 64a and 64b.

When the drawer 67 is inserted in the frames 65, the seal member 68 hermetically seals up the inside of the housing. One of roles of the water 69 stored in the drawer is to capture particles of by-products and keep the particles from rolling up even when the gas flows. Another role of the water 69 is to generate moisture inside the housing to mitigate static electricity generated in the flowing waste gas.

In this case, it is preferable that, as illustrated in FIG. 22, a flow path wall 60c be provided integrally with the partition 60b, and be formed in such a V shape that an upper side of a gas flow path through which the chamber A communicates with the flow path B protrudes downward to bring the flowing waste gas close to the water.

Note that the structure in FIGS. 21 and 22 can be also applied to the horizontal trap in FIGS. 12 and 15. In this case, for example, a tub for storing water is arranged on the support base 41.

### Sixth Modified Embodiment of Trap Device 100b

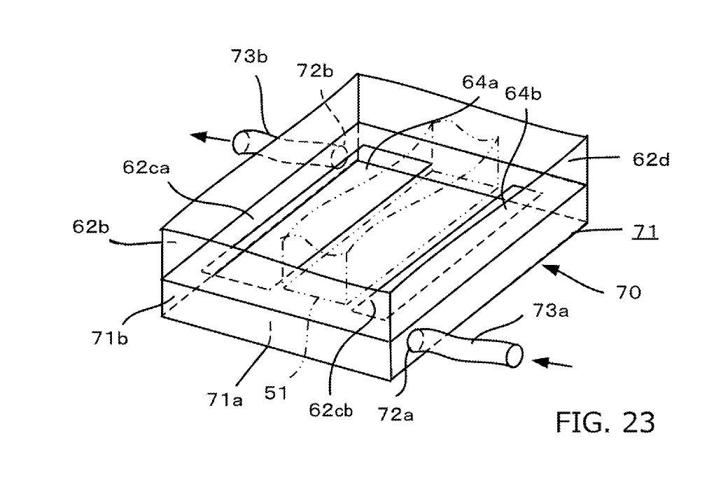

A modified embodiment of the capture unit 66 in the trap 1b in FIG. 21 and. 22 is described with reference to FIG. 23.

FIG. 23 is a perspective view illustrating a capture unit 70 according to a sixth modified embodiment. The capture unit 70 in FIG. 23 includes a water tub 71 instead of the drawer mechanism, and the water tub 71 is formed integrally with the housing of the trap.

In this embodiment, the water tub 71 includes a bottom plate 71a, frames 71b forming side surfaces, and an upper frame 62ca and a mount plate 62cb which form an upper surface. The housing wall forming the bottom surface of the housing of the trap is used as the upper frame 62ca and the mount plate 62cb forming the upper surface. The frames 71b forming the side surfaces are formed of extended portions of all the four side housing walls 62b, 62b, 62b, 62d of the housing. The bottom plate 71a is formed of a plate closing an opened area surrounded by the lower ends of the frames 71b forming the side surfaces.

Moreover, at least two holes communicating with the inside of the tub 71 are formed in at least one of the four frames 71b, 71b, 71b, 71b forming the side surfaces, and are used as a water supply port 72a and a water discharge port 72b for the water. In this embodiment, two opposed frames 71b, 71b are provided with the water supply port 72a and the water discharge port 72b, respectively. In addition, a water supply pipe 73a and a water discharge pipe 73b are connected to the water supply port 72a and the water discharge port 72b, respectively.

This structure is capable of instantly draining by-products generated in the trap by passing the water through the tub 71.

Note that the structure in FIG. 23 can be also applied to the horizontal trap in FIGS. 12 and 15. In this case, for example, a water tub as illustrated in FIG. 23 can be formed by processing the partition 49d forming the flat surface of the semi-cylindrical trap 1. Moreover, it is preferable to form openings in the support base 41, while retaining sufficient strength and safety in order to support the capture bodies 43, 46a, and 46b.

The above-described trap in FIGS. 21 and 23 is inadequate for treatment of a waste gas that is very reactive with moisture. For this reason, care should be taken. In this case, a liquid unreactive with the waste gas can be used.

Moreover, in some cases, water in which the components of a waste gas are dissolved should be subjected to detoxifying treatment. For this reason, the treatment of such waste gas should be carried out with care.

### Seventh Modified Embodiment of Trap Device 100b

With reference to FIG. 24, description is provided for a structure of a trap 1c obtained by further modification of the trap 1a FIGS. 17 and 20.

FIG. 24 is a cross sectional view of the trap 1c. In place of the capture member 51 illustrated in FIG. 18, a gas flow path suitable for cooling the waste gas is set up in the chamber A in FIG. 24. In FIG. 24, elements indicated by the same reference signs as the reference signs in the FIGS. 17 to 20 are the same elements as in FIGS. 17 to 20.

As illustrated in FIG. 24, the chamber A includes a partition 60a, a housing wall 62c, a partition 60b extended to the housing wall 62c, a housing wall 62d provided with a gas inlet 37a, and other housing walls forming side surfaces of the housing.

Flow path forming plates 80a and 80b are alternately fixed to the housing wall 62d and the partition 60b. Three flow path forming plates 80a and three flow path forming plates 80b are used. Here, both sides of the flow path forming plates 80a and 80b in a direction perpendicular to the drawing face of FIG. 24 are also fixed to the other housing walls forming the side surfaces of the housing.

The upper most flow path forming plate 80a is installed such that a space (gas-expanding section) Aa including the gas inlet 37a under the partition 60a can have a relatively large capacity. In this case, a vertical short partition is provided at an end of the flow path forming plate 80a on the partition 60b side, thereby forming the space closed off to some extent. This space determines how much the temperature of the gas drops due to adiabatic expansion.

Under the uppermost flow path forming plate 80a, the other flow path forming plates 80a and 80b are installed at equal intervals smaller than the interval between the partition 60a and the uppermost flow path forming plate 80a. In other words, a zigzag flow path is formed between the flow path forming plates 80a and 80b. The waste gas moves gradually downward while zigzagging between the flow path forming plates 80a and 80b. This structure can establish a longer flow path, and therefore effectively achieve a drop in temperature of the waste gas and generation and removal of by-products.

In the fourth modified embodiment, the capacity of the space that affects a drop in temperature of the gas due to expansion in the chamber A is smaller than the capacities of the corresponding spaces in the above-described traps illustrated in FIGS. 15, 20, and 22, but the space can attain a sufficient drop in temperature in collaboration with the long flow path.

Besides the above-described structure, the trap 1c in FIG. 24 has structural differences in the size of the chamber A and a vent hole allowing the chamber A to communicate with the flow path B. More specifically, a vent hole 61d establishing a relatively long gas flow path through which the waste gas transfers from the chamber A to the flow path B is formed under the lowermost flow path forming plate 80b.

As described above, also in the fourth modified embodiment, even when the high-temperature waste gas enters the trap 1c, the trap is capable of effectively cooling the waste gas and thereby generating and removing by-products from the waste gas.

### Eighth Modified Embodiment of Trap Device

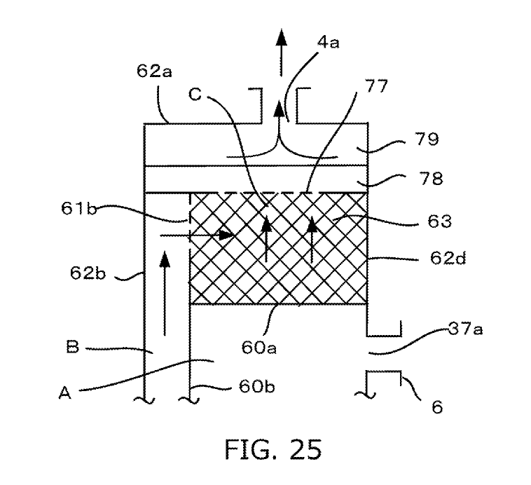

FIG. 25 is a cross sectional view for explaining an eighth modified embodiment of the trap device.

In the following description, an applied example of the eighth modified embodiment is explained by using the traps in the above fourth to seventh modified embodiments, but the eighth modified embodiment is also applicable to the horizontal trap in the embodiment.

In FIG. 25, elements indicated by the same reference signs as the reference signs in the FIGS. 17 to 20 are the same elements as in FIGS. 17 to 20.

In the eighth modified embodiment, as illustrated in FIG. 25, a trap device further includes a filter between the chamber C and the gas outlet 4a. In FIG. 25, reference sign 77 indicates a vent hole leading to the filter 78 from the chamber C, and reference sign 79 indicates a second gas outgoing chamber communicating with the gas outlet 4a.

With this filter 78, finer by-products which remain unremoved in the chamber A, the flow path B, and the chamber C can be removed.

### Ninth Modified Embodiment of Trap Device

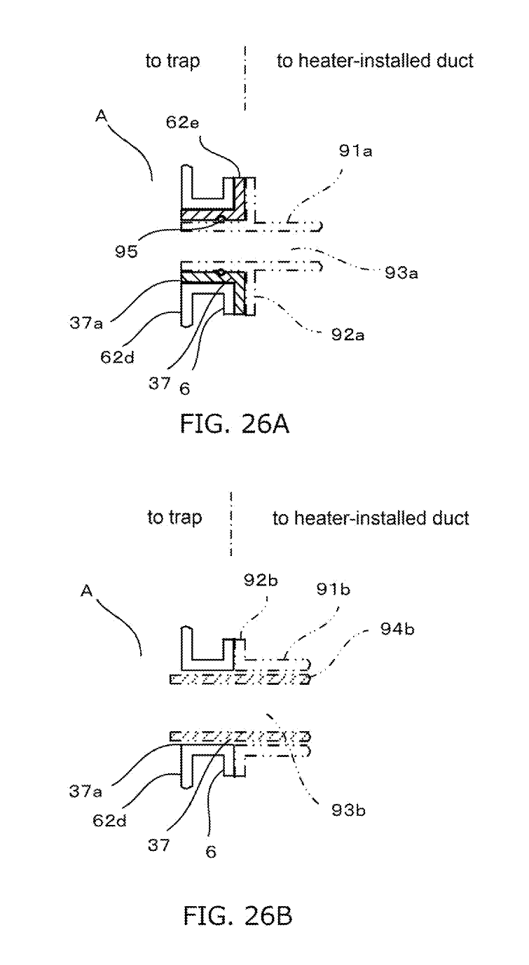

FIGS. 26A and 26B are a cross sectional view (part 1) and a cross sectional view (part 2) for explaining a ninth modified embodiment of the trap device and each illustrate a joint portion between a heater-installed duct and a trap.

In either of FIGS. 26A and 26B, the gas introduction path 37 to 37a leading to the trap is surrounded by an adiabatic material 62e, 94b, so that the flowing waste gas is kept out of contact with the metallic duct of the trap. This aims at preventing the waste gas in the gas introduction path 37 to 37a from being cooled due to contact with the metallic member and generating by-products.

These structures are applicable to a horizontal trap and a trap device using the same, and a vertical trap and a trap device using the same.

In FIG. 26A, a tubular member 62e of the adiabatic material is provided in a fashion fit for the gas inlet 37 having a shape in which an annular portion serving as the flange 6 and a cylindrical portion serving as the gas introduction path 37 to 37a are joined together. In other words, the tubular member 62e has a shape close-fitting to the shape from the surface of the flange 6 to the cylindrical inner surface forming the gas introduction path 37 to 37a. As the adiabatic material, for example, Teflon (registered trademark) may be used.

The heater-installed duct desirably includes a joint portion having the shape as illustrated in FIG. 26A and described below. Specifically, a metallic gas outlet duct 91a is provided with a flange 92a, and is extended beyond the flange 92a to the trap so as to reach at least the chamber A when inserted into the gas introduction path 37 to 37a. The flange 92a of the gas outlet duct 91a is joined to the flange-corresponding portion of the tubular member 62e, and a gas introduction path 93a is formed inside the gas outlet duct 91a.

Here, reference sign 95 is an elastic seal member. When the gas outlet duct 91a is inserted, the gas outlet duct 91a and the seal member 95 are brought into airtight contact with each other to keep airtightness of the inside of the trap.

Meanwhile, FIG. 26B illustrates an example of a structure similar to FIG. 11. Specifically, out of double gas-conducting pipes 91b, 94b, the outer pipe 91b is made of a metal, for example, stainless steel, whereas the inner pipe 94b is formed of a tubular member of an adiabatic material. Further, the inner pipe 94b is extended to the inside of the chamber A beyond the gas introduction path 37 to 37a of the trap. A space surrounded by the inner pipe 94b is a gas introduction path 93b.

Here, the flanges 6 and 92b are joined together to connect the double gas-conducting pipes 91b and 94b to the trap.

Although FIG. 11 illustrates the example where the communication member 8b is the flow path selector switch 21, the above-described structures are also applicable to the cases where the communication members 8 and 8a in FIGS. 1B and 4 are used.

Hereinabove, the invention has been described in detail using the embodiments. However, the scope of the invention should not be limited to the examples specifically illustrated in the above-described embodiments, but also includes modifications of the above-described embodiments without departing from the spirit of the invention.

For example, the rotary tool 25, 25a in the flow path selector switch 21, 21a illustrated in FIG. 6 or 10 has a cylindrical or semi-cylindrical shape, but the shape is not limited to these. The shape may be a tubular shape with an arc at any desired angle in plan view.

Moreover, the double gas-conducting pipes illustrated in FIG. 11 are applied to the first gas flow path 35a immediately before the trap in the communication member 8b of the trap device 100b in FIG. 5, but may be applied to the gas flow path in the communication member 8 of the trap device 100 in FIG. 1 or the gas flow path in the communication member 8a of the trap device 100a in FIG. 4.

Further, regardless of whether the standby trap having the same structure as the trap 1 of the trap device 100b is connected or not connected to the second gas flow path 32a, the double gas-conducting pipes illustrated in FIG. 11 may be applied to the second gas flow path 32a.

Moreover, the fourth to the ninth modified embodiments are those in case that the trap device of FIG. 5 is modified to a vertical trap. The same modified embodiments as those are available in case that each of the trap devices of FIGS. 1 and 4 is modified to the vertical trap.

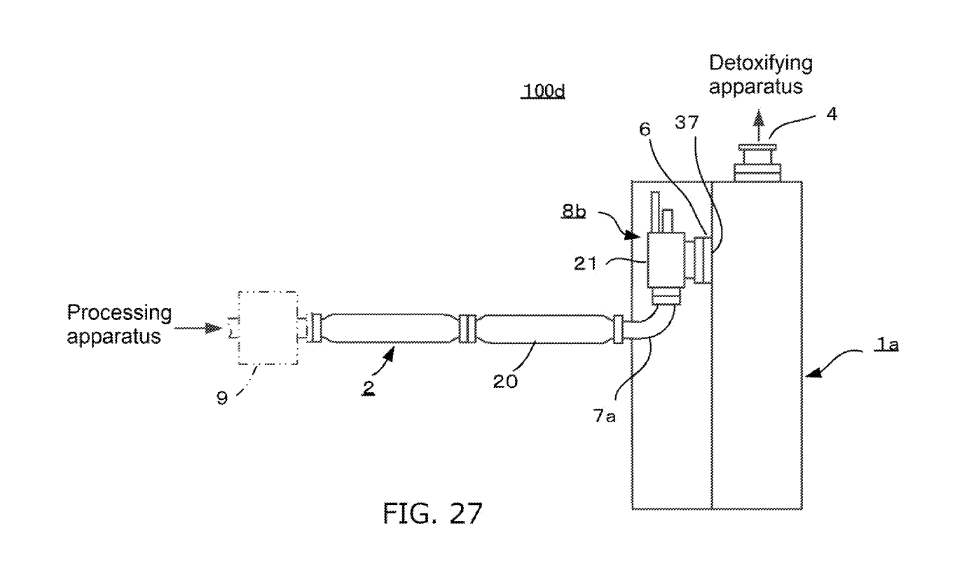

In addition, the trap device in each of the above-described embodiments, the heater-installed duct and the trap are connected through the communication member, but the communication member connected to the trap and the heater-installed duct may be connected through at least one normal duct with no heater as illustrated in FIG. 27 concerning a trap system.

In this case, it is necessary to thermally insulate the normal duct by wrap an adiabatic member around the outer surface of the duct, and to set the temperature of the heater such that the waste gas temperature in the gas introduction path of the trap can be kept higher than the upper limit of a temperature range in which by-products will be generated.

According to the above-described structure, the waste gas is directly heated in the gas flow path. Thus, the waste gas can be more efficiently heated by using a smaller amount of electric power than in a conventional case where a ribbon heater is wound around the outer circumference of the duct.

Moreover, since the fins 17 are provided around the outer circumference of the heater in the duct, the flowing waste gas is disturbed by the fins 17 and thereby has good temperature uniformity. Hence, the waste gas undergoes only a small change in temperature while passing the trap inlet.

In particular, the circumference of the gas introduction path of the trap inlet is surrounded by the adiabatic member as illustrated in FIGS. 26A and 26B, which enables suppression in a drop in temperature of the water gas around the trap inlet and accordingly a reduction in the power consumption of the heater for heating the waste gas.

Thus, the waste gas can be heated with a smaller temperature margin. Accordingly, before the waste gas enters the inside of the trap 1, generation of by-products can be prevented more reliably by using a smaller amount of electric power.

It should be noted that, in the case of a ribbon heater, the ribbon heater heats the waste gas through the duct wall from outside of the duct, and nothing is installed inside the duct. In this case, the temperature in the duct is high on the duct side and becomes lower toward the center of the duct, and it is difficult to make the temperature uniform. For this reason, a large temperature margin is inevitably required even if an adiabatic member is installed.

1. A trap comprising:
a housing including a gas inlet and a gas outlet;
a gas introduction chamber provided in the housing and including the gas inlet;
a first gas flow path provided in the housing and communicating with the gas outlet;
a partition separating the gas introduction chamber and the first gas flow path; and
a vent hole provided in the partition.

2. The trap according to claim 1, wherein
a capture member is installed between the gas inlet and the vent hole in the gas introduction chamber.

3. The trap according to claim 1, wherein
the gas introduction chamber is provided, between the gas inlet and the vent hole, with a gas-expanding section including the gas inlet, and a second gas flow path arranged downstream of the gas-expanding section and conducting a gas in a zigzag manner.

4. The trap according to claim 1, wherein
the first gas flow path includes a gas outgoing chamber including the gas outlet, and a capture member installed in the gas outgoing chamber.

5. The trap according to claim 1, wherein
a liquid storage section is provided in such a fashion that a liquid surface in the liquid storage section is exposed on a bottom of the gas introduction chamber.

6. The trap according to claim 1, wherein
the housing includes a gas introduction path leading to the gas inlet of the gas introduction chamber from outside the housing, and
the gas introduction path is formed inside a tubular member of an adiabatic material.

7. A trap system comprising:
a heater-installed duct including a heater in a first gas flow path through which a waste gas flows;
a duct through which the waste gas discharged from the heater-installed duct flows; and
a trap including
a housing including a gas outlet and a gas inlet introducing the waste gas discharged from the duct,
a gas introduction chamber provided in the housing and including the gas inlet,
a second gas flow path provided in the housing and communicating with the gas outlet,
a partition separating the gas introduction chamber and the second gas flow path, and
a vent hole provided in the partition.

8. A trap device comprising:
a first gas inlet introducing a waste gas;
a heater-installed duct connected to the first gas inlet and provided with a heater installed in a first gas flow path through which the introduced waste gas flows;
a trap capturing waste gas by-products formed by cooling the waste gas after the waste gas flows through the heater-installed duct; and
a communication member connecting the heater-installed duct to the trap to permit the heater-installed duct to communicate with the trap.

9. The trap device according to claim 8, wherein
the trap includes
a housing including a second gas inlet and a first gas outlet,
a gas introduction chamber provided in the housing and including the second gas inlet,
a second gas flow path provided in the housing and communicating with the first gas outlet,
a partition separating the gas introduction chamber and the second gas flow path, and
a first vent hole provided in the partition.

10. The trap device according to claim 9, wherein
a capture member is installed between the second gas inlet and the first vent hole.

11. The trap device according to claim 9, wherein
the gas introduction chamber is provided, between the second gas inlet and the first vent hole, with a gas-expanding section including the second gas inlet, and a third gas flow path arranged downstream of the gas-expanding section and conducting the waste gas in a zigzag manner.

12. The trap device according to claim 10, wherein
the capture member includes a capture body in which a plurality of slender and flexible rod members or a plurality of slender and flexible plate members are bundled.

13. The trap device according to claim 9, wherein
the second gas flow path includes a gas outgoing chamber including the first gas outlet, and a capture member installed in the gas outgoing chamber.

14. The trap device according to claim 9, wherein
a liquid storage section is provided in such a fashion that a liquid surface in the liquid storage section is exposed on a bottom of the gas introduction chamber.

15. The trap device according to claim 9, wherein
the housing includes a gas introduction path leading to the second gas inlet of the gas introduction chamber from outside the housing, and
the gas introduction path is formed inside a tubular member of an adiabatic material.

16. The trap device according to claim 8, wherein
the communication member includes
a fourth gas flow path configured to conduct the waste gas discharged from the heater-installed duct to the trap,
a fifth gas flow path configured to conduct the waste gas to a discharging side, and
a gas flow path selector switch configured to divert the waste gas to any one of the fourth gas flow path and the fifth gas flow path.

17. The trap device according to claim 16, wherein
the fourth gas flow path is formed inside a tubular member of an adiabatic material.

18. The trap device according to claim 17, wherein
the flow path selector switch includes
a cylindrical outer wall,
a third gas inlet provided at a lower end of the cylindrical outer wall and configured to introduce the waste gas discharged from the heater-installed duct,
a second vent hole provided at a side surface of the cylindrical outer wall and communicating with the fourth gas flow path,
a tubular rotary tool rotating along an inner surface of the cylindrical outer wall,
a third vent hole provided at a side surface of the tubular rotary tool and mated to the second vent hole with rotation of the rotary tool,
a first cover member covering an upper end of the tubular rotary tool, the first cover member configured to rotate together with the rotary tool,
a fourth vent hole provided at a predetermined location of the first cover member,
a second cover member covering an upper end of the cylindrical outer wall,
a fifth vent hole provided at a predetermined location of the second cover member, and mated to the fourth vent hole to communicate with the fifth gas flow path with rotation of the rotary tool, and
a rotary shaft provided to stand on the first cover member and projecting upward from the second cover member through a through-hole provided in the second cover member.
